(19) United States
(12) Patent Application Publication
(10) Pub. No.: US 2003/0154063 A1
(43) Pub. Date: Aug. 14, 2003

(54) Active path extraction for HDL code

(76) Inventors: Martin Lu, Hsin-Chu City (TW); Chia-Huei Lee, Hsin-Chu City (TW); Ming-Chih Lai, Taipei Hsien (TW)

Correspondence Address: NAIPO (NORTH AMERICA INTERNATIONAL PATENT OFFICE), P.O. BOX 506, MERRIFIELD, VA, 22116, US

(21) Appl. No.: 09/683,739

(22) Filed: Feb. 8, 2002

(51) Int. Cl. G06F 17/50; G06F 9/44; G06F 13/10

(52) U.S. Cl. 703/14

(57) ABSTRACT

Start and stop signals are obtained from a user, with associated start and stop times, as well as circuit simulation results. The simulation results are utilized to determine which of the components in the circuit are active components, which are any components that have an active output signal. Active output signals obtain a state between the start and stop times in response to a state change of the start signal. The user output equipment is utilized to provide the active components and the active output signals to the user. Signal activity is presented in a graphical form that shows the active path circuit, and active value changes that cause output signals to become active. The user may select time values at which signals become active to see in a graphical manner the propagation of a start signal state change through the circuit.

### BACKGROUND OF INVENTION

1. Field of the Invention

The present invention relates to hardware description language (HDL). More specifically, the utilization of simulation results and HDL code to obtain active components in a circuit is disclosed.

2. Description of the Prior Art

Increasingly, electrical engineers are turning to software to design and test circuits. In particular, hardware description language (HDL) code, such as VHDL and Verilog, is being used to design circuits. HDL is somewhat like a programming language, and HDL code is used to represent a circuit. HDL code has a direct relationship to physical circuit components. An electric circuit can thus be directly built using the HDL code as a schematic. A simulator parses the HDL code, in effect running the circuit, over a simulated time range with predetermined input values, and obtains simulated output values. Along the way, the simulator generates state changes of all signals within the circuit over the simulated time range.

To ensure that a circuit is properly coded in HDL, and hence ensuring that the circuit is properly designed, input signals at predetermined times (so-called verification vectors) are used during the simulation, and the resultant output is checked against desired results. Deviations from desired results are signs of design errors, and the HDL code must be debugged to correct the error. As the complexity of circuit designs increases, the number of verification vectors required to ensure the proper operations of a circuit design grows exponentially with the number of components within the circuit. When an error is detected in the simulated output, difficulty in locating the error source grows with the number of components in the circuit. Current circuit designs can contain millions of components, and errors in the design may propagate out after extended time periods, spanning many components. Circuit designers thus waste a great deal of time and effort tracing the causes of incorrect circuit behavior.

Additionally, most circuit designs are the result of teamwork. In a single circuit, it is possible to find HDL code written for components by people from all around the world. Because of this, when debugging, engineers are often faced with unfamiliar circuit designs (i.e., unfamiliar HDL code). In order to fully grasp a circuit design, an engineer must analyze the HDL code, simulation data and the design specifications. Simulation data, however, only presents value changes of signals within the circuit, and shows none of the relationships and interactions between the signals. The HDL code, on the other hand, simply conveys a static description of the circuit, much as a blueprint would. In order to understand the dynamic behavior of the design, an engineer must study and cross-reference the HDL code with the simulation results. For example, in order to understand the reason for a value change in a signal, an engineer must utilize the HDL code to find all other signals that affect the signal in question. Not necessarily all signals that are connected to this signal will cause the noted value change. Designers and debuggers need to locate only those signals that are truly a source of the value change of the signal, and do this by referencing the simulation results. An engineer, or team of engineers, may then wish to probe deeper into the circuit to obtain the entire region that affects the value change of the signal in question. This region may contain thousands of signal paths. Using such traditional methods, a complex circuit design could require well over a day to find the root cause of a single value change to a signal, and further requires perhaps more than just a little conjecture about the behavior of the circuit.

### SUMMARY OF INVENTION

It is therefore a primary objective of this invention to provide a method and associated computer system that utilizes HDL code and simulations results to extract an active path within a circuit. Such an active path includes all active signals that affect the output of a component, all signals actively affected by the output of a component, or active signals that connect one signal to another signal.

It is another objective of this invention to produce a graphical representation of extracted active paths, enabling a user to see the propagation of an active signal with time through the active path.

Briefly summarized, the preferred embodiment of the present invention discloses a method and computer system for active path extraction of hardware description language (HDL) code. The computer system has user input equipment for accepting input from a user, and user output equipment for providing output to the user. The HDL code represents an electronic circuit having a plurality of components, each component having at least an input signal and an output signal. The user input equipment is used to obtain a start signal from the user, and to obtain a stop signal from the user. The user input equipment is also used to obtain a start time and an end time. Simulation results of the electronic circuit are obtained from a simulator that utilizes the HDL code, the simulation results having state changes of the output signals and the input signals. The HDL code is parsed to obtain a circuit connection graph between the start signal and the stop signal. The connection graph comprises components, input signals, and output signals that electrically connect the start signal to the stop signal. The simulation results are utilized to determine which of the components in the circuit connection graph are active components. An active component is any component in the circuit connection graph that has an active output signal. An active output signal is any output signal of any component in the circuit connection graph that obtains a state between the start time and the stop time in response to a state change of the start signal. Finally, the user output equipment is utilized to provide the active components and the active output signals to the user. Signal activity is presented on a display in a graphical form that shows the active path circuit, and active value changes that cause output signals to become active. The user may select time values at which signals become active to see in a graphical manner the propagation of a start signal state change through the circuit.

It is an advantage of the present invention that by extracting active paths for a user-selected signal or signals, an engineer can more quickly come to understand the interactions between signals in a circuit, and hence better realize how a signal change at one region of a circuit directly affects the output in another region of the circuit. This greatly reduces the amount of time needed to debug a circuit, and hence to correct the underlying HDL code. Circuit design times are therefore reduced. Graphically presenting the extracted active paths in a time-based manner shows the propagation of active signals, and enables a better understanding of the dynamic nature of a circuit.

These and other objectives of the present invention will no doubt become obvious to those of ordinary skill in the art after reading the following detailed description of the preferred embodiment, which is illustrated in the various figures and drawings.

### BRIEF DESCRIPTION OF DRAWINGS

FIG. 1 is a simple logic diagram to illustrate active signals.

FIG. 2 is a signal timing diagram for the circuit of FIG. 1.

FIG. 3 is a simple logic circuit to further illustrate active signals.

FIG. 4 is a timing diagram of the logic circuit of FIG. 3.

FIG. 5 is a block diagram of a computer system according to the present invention.

FIG. 6 is a flow chart for a forward search engine according to the present invention.

FIG. 7A to FIG. 7C contain listings of sample hardware description language (HDL) code.

FIG. 8 provides a graphical illustration of a circuit connection graph for the HDL code of FIG. 7A to FIG. 7C.

FIG. 9 provides a graphical illustration of a statement tree for a component listed in FIG. 7B.

FIG. 10 is a signal timing diagram for the circuit represented by the HDL code of FIGS. 7A to 7C.

FIG. 11A is a flow chart for a forward search algorithm according to the present invention.

FIG. 11B is a simple block diagram of a forward search algorithm according to the present invention.

FIG. 12 provides a graphical illustration of a statement tree for a component listed in FIG. 7C.

FIG. 13 provides a graphical illustration of a statement tree for a component listed in FIG. 7A.

FIGS. 14A-14D illustrate various displays of an active path extracted by a forward search engine according to the present invention.

FIG. 15 is a flow chart for a backward search engine according to the present invention.

FIG. 16A is a flow chart of a backward search algorithm according to the present invention.

FIG. 16B is a simple block diagram of a backward search algorithm according to the present invention.

FIG. 17 is an example active path extracted by a backward search engine according to the present invention.

FIG. 18 is a flow chart for a point-to-point search engine according to the present invention.

FIG. 19 is an example active path extracted by a point-to-point search engine according to the present invention.

### DETAILED DESCRIPTION

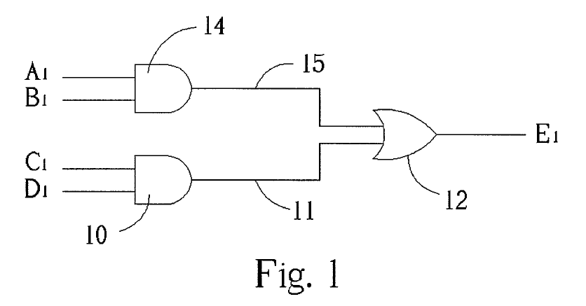

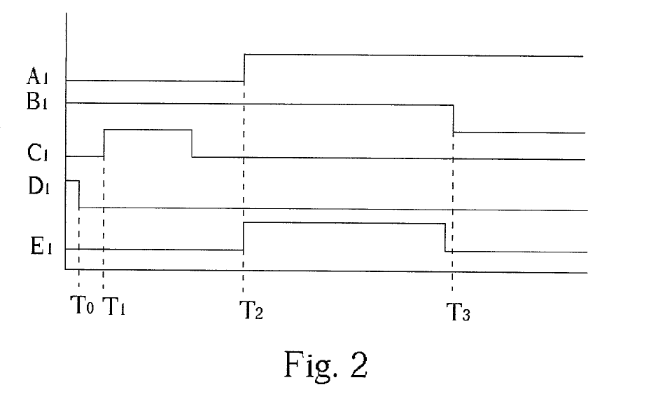

Please refer to FIG. 1 and FIG. 2. FIG. 1 is a simple logic diagram to illustrate active signals. FIG. 2 is a signal timing diagram for the circuit of FIG. 1. Generally, to find active signals in a circuit, it is necessary to first indicate a start signal and a start time. This start signal undergoes a value change at the start time, and any signals which are affected by this value change are considered active signals. This is termed a forward search, as the searching for active signals and active components is performed in a forward manner with respect to time. It should be noted here that an active component is any component that has an active output signal. As an example of forward searching, consider using an input signal C₁ for AND logic component 10 as a start signal. C₁ undergoes a value transition at time T₁, which is taken as the start time, going from a logical zero to a logical one. However, input D₁, at an earlier time T₀, transitions from one to zero. As a result, the output signal 11 of AND gate 10 is always zero from time T₀ on. With respect to start signal C₁, then, output 11 is not an active output signal on or after start time T₁. That is, the value change of C₁ at time T₁ does not affect the output signal 11 of the AND logic component 10. If output signal 11 is not an active output with respect to C₁, then output signal E₁ of OR logic component 12 is thus also not affected, and so output signal E₁ is not an active signal with respect to C₁. On the other hand, consider taking input signal A of AND logic component 14 as the start signal. Input signal A₁ transitions from zero to one at a time T₂ (which may be taken as the start time), and as a result of this output signal 15 transitions from zero to one as well. Output signal 15 is thus an active output of AND logic component 14, from time T₂, and feeds into OR logic component 12. AND logic component 14, from time T₂, therefore is an active component. As a result of the output signal 15 going from zero to one, the output signal E₁ transitions from zero to one as well. Output signal E₁ is thus an active output with respect to start signal A₁. If propagation delays are ignored, then output signal E₁ becomes an active output at time T₂. OR logic component 12 is thus an active component as well, at time T₂. The active path of A₁ is thus: A₁, AND logic component 14 (input B₁, at a value of one, can be ignored), active output signal 15, OR logic component 12 (input signal 11, with a value of zero, can be ignored), and finally active output E₁. Note, then, that AND logic component 10, and associated inputs C₁ and D₁, are not part of the active path of A₁ at time T₂. Further note that at time T₃, E₁ is no longer affected by A₁. Thus, the active path of A₁ with a start time of T₂ spans not only affected components and signals, but also an execution time. Active paths thus generally have not only associated start times, but also end times. In this example, the end time of the active path for A₁ would be time T₃.

The above is a forward search, in that one has a start signal and works forward in time to find active signals. This is analogous to a fan-out cone of the start signal. One may also, however, work backwards. That is, a stop signal may be selected, which undergoes a value change at a stop time, and working backwards in time, input signals are found that are responsible for the value change of the stop signal. This is analogous to the fan-in cone of the stop signal, and is termed a backwards search. Active paths found by forward searches need not be the same as those found by backward searches. As an example of backward searching, E₁ may be taken as the stop signal, and the zero-to-one transition of E₁ at time T₂ as the stop time. Working backwards from the stop time T₂, for E₁ to have made such a zero-to-one transition, either input signal 11 or input signal 15 must have made a similar zero-to-one transition. Input signal 15 of OR logic component 12 is the signal that underwent such a transition, and is thus an active input signal. As signal 15 is an active signal, it is an active output signal of AND logic component 14. For active output signal 15 to make a zero-to-one transition, both input B and input A must be one. A and B are thus both considered active input signals, as both are required to be one to generate a one output on signal 15. Using E as a stop signal, then, the active path of E₁ at time T₃ is: E₁, OR logic component 12, signal 15, AND logic component 14, signal A₁ and signal B₁.

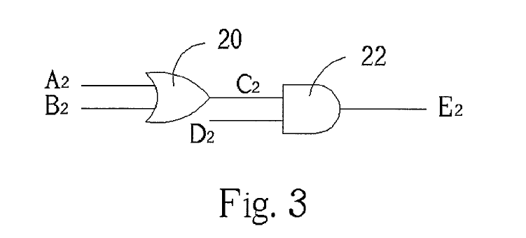

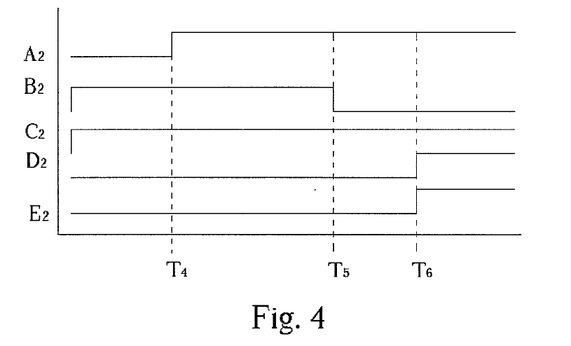

Generally, it is quite clear when a start signal affects other signals and other components, such affected signals and components thus being active signals and active components of the start signal. However, at times, there may be a certain amount of ambiguity. As an example of this, please refer to FIG. 3 and FIG. 4. FIG. 3 is a simple logic circuit. FIG. 4 is a timing diagram of the logic circuit of FIG. 3. Consider a forward search using A₂ as a start signal and T₄ as a start time. A question arises as to whether C₂ is an active output at time T₄. For an output signal to be an active output, the output signal must have the active input signal as a required parameter for the value of the output signal. In the present example of output C₂, this requires that the value of C₂ at time T₄ be at least in part determined by A₂. As B₂ is a logical one at time T₄, the question arises as to whether C₂ is active at time T₄, or instead at time T₅, when B₂ goes to a logical zero. As a circuit component is a well-defined entity, the output of a circuit component at any given time can always be represented mathematically as a function of the input components, and possibly other internal variables. This equation can then be parsed against predetermined rules to determine if the active input signal is a required variable for the output signal. If the active input signal is determined to be a required parameter for the output signal, then the output signal is considered an active output signal. The equation for output C₂ is quite straightforward:

C₂=A₂|B₂

In the above, the symbol “|” indicates a Boolean OR operation. This equation for C₂ is then parsed against a rule table for the Boolean OR operation to determine if A₂ signal. For the present invention, the rule table for the Boolean OR presented below:

TABLE 1
OR operator rules

| | Active input | | Active input a required |
|---|---|---|---|
| Output value | value | Other input value | input? |
| 1 | 0 | 1 | No |
| 1 | 1 | 0 | Yes |
| 1 | 1 | 1 | Yes |
| 0 | 0 | 0 | Yes |

At time T₄, A₂ is a one, and B₂ is a one. The value of A₂ at time T₄ is the “Active input value” of Table 1, and that for B₂ is the “other input value”. Thus, according to Table 1, at time T₄, A₂ is a required input for the value of C₂, and hence C₂ is an active output signal. The rules of Table 1 have the effect that OR gate 20 becomes active at time T₄ (i.e., that C₂ becomes an active output at time T₄), rather than becoming an active component at time T₅. It should be understood, however, that other rule tables could be constructed so that C₂ becomes active at time T₅, rather than time T₄. Exactly how one wishes to construct rule tables is an implementation choice. Table 2 below is a rule table for the Boolean AND operation:

TABLE 2
AND operator rules

| | Active input | | Active input a required |
|---|---|---|---|
| Output value | value | Other input value | input? |
| 0 | 0 | 0 | Yes |
| 0 | 0 | 1 | Yes |
| 0 | 1 | 0 | No |
| 1 | 1 | 1 | Yes |

A forward search using Table 1 thus determines that OR gate 20 becomes an active component at time T₄, with an active output signal C₂. C₂ is then used as an active input in another forward search. C₂ is an active input for AND gate 22. At time T₄, output E₂ of AND gate 22 is zero. The output equation for AND gate 20 is simply:

E₂=C₂ & D₂

The symbol “&” indicates a Boolean AND operation. Using Table 2 above, with the value of C₂ at time T₄ as the active input value, and that for D₂ as the other input value, it is determined that at time T₄ C₂ is not a required signal for the output value of E₂. At time T₄, then, AND gate 22 is not an active component. However, at time T₆, input D₂ rises to a logical one, and then, according to the rules of Table 2, C₂ becomes a required signal for the value of E₂. Thus, at time T₆ AND gate 22 becomes an active component, with E₂ an active output. Consequently, a forward search engine must not only iterate through all found active outputs, but must also search forward through time to find those situations in which an output signal may become an active signal when it had been previously masked by another signal. Further, an output signal may become an active output without necessarily undergoing a value change.

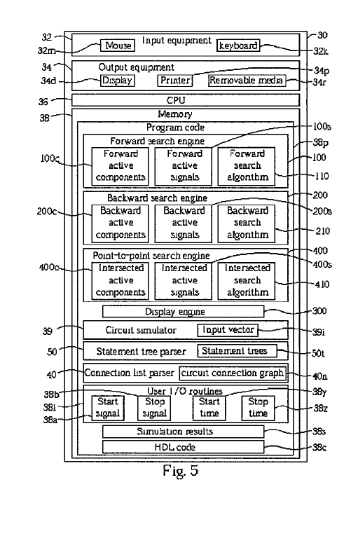

Please refer to FIG. 5. FIG. 5 is a block diagram of a computer system 30 according to the present invention, which is used to extract active paths. The computer system 30 includes input equipment 32, output equipment 34, a central processing unit (CPU) 36 and memory 38. The input equipment 32 will typically include a mouse 32m and a keyboard 32k, and is used to provide user input data to the computer system 30. The output equipment 34 is usually a display 34d, such as a cathode ray tube (CRT) or a liquid crystal display (LCD), and is used to present extracted active paths to the user. Alternatively, a printer 34p may also be used to present active paths to the user. For most modern operating systems, controlling a display 34d is nearly identical to controlling a printer 34p, and hence generalized software may be easily coded that is capable of writing to both a display 34d and printer 34p without much significant overhead. Even removable media 34r, such as a magnetic or optical media, may be used as a user output device 34. In this case, a computer-readable file is written onto the removable media 34r in a manner known in the art, which contains the extracted active paths found by the computer system 30. The CPU 36 controls the operations of the computer system 30, and to do so executes program code 38p in the memory 36. The memory 38 may be both volatile memory, such as dynamic random access memory (DRAM), or non-volatile memory, such as a hard disk; differences between the two are frequently blurred by virtual memory management, which is provided by an operating system of the computer system 30.

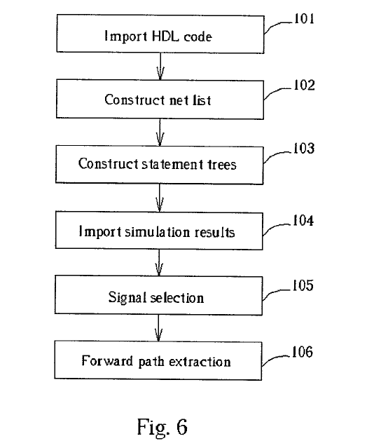

To perform a forward search to extract active paths, the program code 38p includes a forward search engine 100. Please refer to FIG. 6 with reference to FIG. 5. FIG. 6 is a flow chart for the forward search engine 100. The steps of FIG. 6 are discussed at length in the following.

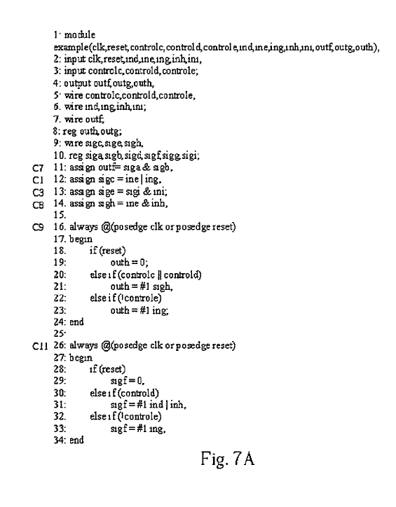

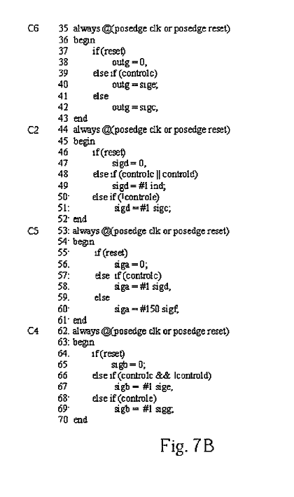

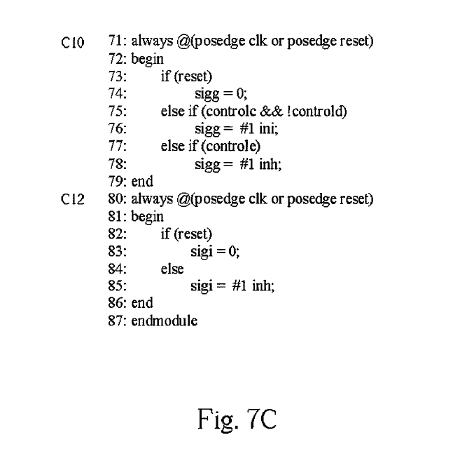

In step 101, the forward search engine obtains HDL code 38c, which is placed into the memory 38. The removable media 34r may be used to obtain the HDL code 38c. Often, however, the HDL code 38c already resides in the memory 38, and the forward search engine 100 is simply directed to the location of the HDL code 38c (i.e., is provided the filename of the HDL code 38c). A set of user input/output (I/O) routines 38i is usually provided for this purpose, and will include standardized code to obtain a filename from the user from which the HDL code 38c may be obtained. To better illustrate the methodology of the forward search engine 100, example HDL code 38c is provided in FIG. 7A to FIG. 7C.

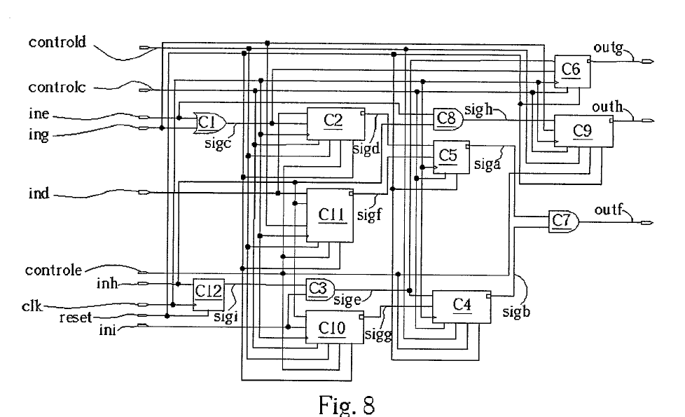

In step 102, the HDL code 38c is passed to a connection list parser 40 to generate a circuit connection graph 40n. The circuit connection graph 40n simply indicates the connectivity of the various components within the HDL code 38c, and enables the forward search engine 100 to determine which signals are connected to which components within the HDL code 38c. FIG. 8 provides a graphical illustration of a circuit connection graph 40n for the sample HDL code 38c of FIG. 7A to FIG. 7C. Construction and use of such circuit connection graphs 40n should be familiar to those in the art of HDL simulators.

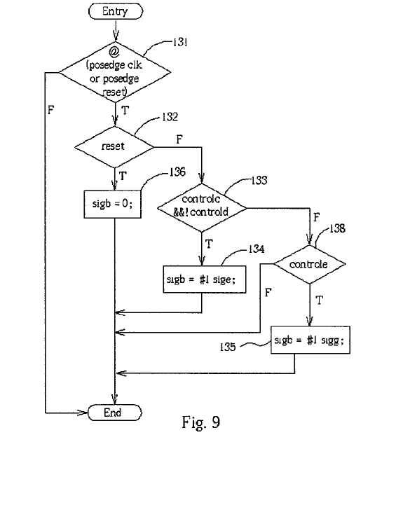

In step 103, statement trees 50t are constructed by a statement tree parser 50. The statement tree parser 50 reads in the HDL code 38c, and in a manner known to those familiar with the design of simulators and compilers, generates the statement trees 50t. When presented visually, such as on the display 34d, or via hardcopy output from the printer 34p, each statement tree 50t looks much like a flow chart graph. It is noted that HDL code is used to represent the functionality of circuit components, and the connectivity between these components. Each component is represented by at least one line of HDL code. For example, the HDL code of FIGS. 7A to 7C has twelve components, C1 to C12, the code for each of which is found on or after a corresponding label in the leftmost column of the code listing. Each statement tree 50t may be thought of as a flow chart for a component (i.e., C1 to C12) in the HDL code 38c. An example statement tree 50t for component C4 is shown in FIG. 9. Referencing the code listing for C4, found in FIG. 7B, it is clear that visually, at least, the statement tree 50t for component C4 is simply a flow chart. Internally, however, each statement tree 50t is composed of at least one instruction node. Instruction nodes have links to other instruction nodes to indicate the potential execution flow of the component (as performed by an HDL simulator), and may have one or more links depending on the instruction node type. In FIG. 9, conditional instruction nodes are indicated by diamonds, and have two links each: one for true evaluations, the other for false evaluations. Assignment instruction nodes are indicated by rectangles, and have a single link. Each instruction node is used to hold a single logical line of HDL code, which is indicated by the text inside the instruction nodes of FIG. 9. Of course, how one wishes to actually internally hold the information that relates to the logical line of HDL code within an instruction node is a design choice. However, it is essential that a complete execution flow path for a component, including all assignments and conditional evaluations, be extractable from the statement tree 50t for the component.

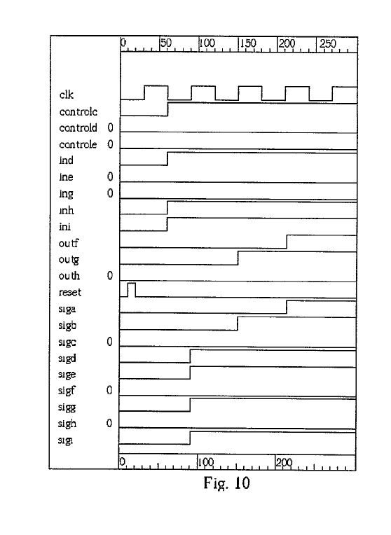

In step 104, simulation results 38s for the HDL code 38c are imported. In a manner analogous to the importing of the HDL code 38c, the user I/O routines 38i may be used to indicate where the simulation results 38s are to be found (i.e., the filename and path to the simulation results 38s, or a network location). Alternatively, a circuit simulator 39 may be used to directly generate the simulation results 38s. The simulator 39 is provided input vectors 39i that provide input conditions for the circuit represented by the HDL code 38c. The circuit simulator 39 then reads in the HDL code 38c, utilizing the input vectors 39i, to generate the simulation results 38s over a predetermined simulated execution time. The simulation results 38s hold state changes of all signals in the circuit represented by the HDL code 38c over the simulated execution time. Hence, at any simulated execution time, the state of any signal as defined by the HDL code 38c may be extracted from the simulation results 38s. Sample simulations results 38s are shown in FIG. 10 for the HDL code 38c of FIGS. 7A to 7C. The program code 38p is capable of presenting the simulation results 38s on the display 34d in the form of timing diagrams.

In step 105, the user I/O routines 38i are used to provide an interface that enables the user to select a start signal 38a and a start time 38y. Many known input methods are available to obtain this data. For example, by using the mouse 32m, a user may select a waveform within a timing diagram of the simulation results 38s presented on the display 34d to select a start signal 38a; the particular location clicked upon in the waveform would indicate the start time 38y. Alternatively, the user may use the keyboard 32k to explicitly type in both the start signal and the start time. Similarly, the user I/O routines 38i are also used to select a stop signal 38b and a stop time 38z. The forward search engine 100 begins with the start signal 38a as the first active input signal, and progresses forward in time to find the active path until either the stop signal 38b is reached, or the stop time 38z is exceeded. Default values are used if any parameter is not selected by the user. For example, if the user does not select a stop signal 38y, then all final output signals of the circuit represented by the HDL code 38c are used by default; this would be the signals outg, outh and outf of the example circuit as shown in FIG. 8. Similarly, if no stop time 38z is indicated, then the last execution time held within the simulation results 38s is used for the stop time 38z. Default values for the input signal 38a would include all initial input signals of the circuit represented by the HDL code 38c; this would include controld, controlc, ine, ing, ind, controle, inh and ini of the example circuit shown FIG. 8. Certain signals are generally ignored by default as they are ubiquitous throughout the circuit, and hence would, by their nature, include every component; such signals include clock and reset signals. It should be noted here that a user may also explicitly request that a signal be ignored, and so not included in any subsequent active path extraction results. It should also be noted that if the user selects a start time 38y that does not correspond to a value change of the start signal 38a, then the forward search engine 100 will select a new start time 38y that lies closest to the user-selected start time and that is on a transition of the start signal 38a.

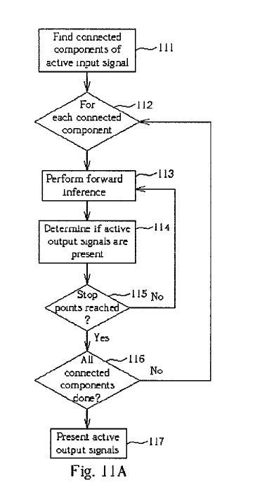

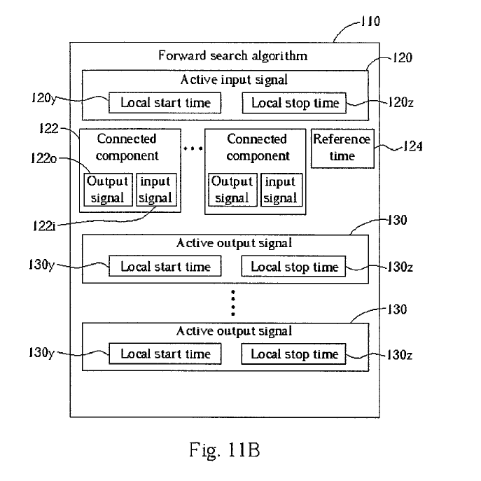

Using the information gleaned from steps 101 to 105, the forward search engine 100 then reiteratively calls a forward search algorithm 110 to obtain forward active components 100c and forward active signals 100s. Please refer to FIG. 11A and FIG. 11B. FIG. 11A is a flow chart for the forward active search algorithm 110, the steps of which are enumerated below. FIG. 11B is a simple block diagram of the forward search algorithm 110. Generally speaking, the forward search algorithm 110 accepts as input an active input signal 120, a local start time 120y of the active input signal 120, and a local stop time 120z of the active input signal 120. The forward search algorithm 110 generates active output signals 130 from the input data 120. Each active output signal 130 has an associated local start time 130y and a local stop time 130z. These active output signals 130, and associated start and stop times 130y and 130z, are then used as inputs 120 in subsequent iterations of the forward search algorithm 110 to traverse the entire active path. Successive iterations continue until the stop time 38z is exceeded or a stop signal 38y is reached. In the first call to the forward search algorithm 110, the start signal 38a is used as the input active signal 120, the start time 38y as the local start time 120y, and the stop time 38z as the local stop time 120z.

111: The circuit connection graph 40n is used to determine all components that are directly connected to the active input signal 120. Such components are termed connected components 122.

112: Each connected component 122 is then individually considered across the local start time 120y and local stop time 120z in the following steps. A reference time 124 is initially set to the local start time 120y.

113: For the connected component 122 under consideration, obtain the associated statement tree 50t. Then, index into the simulation results 38s according to the reference time 124 to determine the execution path of the connected component 122 immediately at and after the reference time 124. In effect, this traces the steps that the circuit simulator 39 took at the reference time 124 to generate the value for an output signal 122o of the connected component 122. Each instruction node that was executed to generate the output 122o of the connected component 122 is noted, and is termed an executed instruction node.

114: Using the executed instruction nodes found in step 113, an equation is generated that equals the output value 122o of the connected component 122 according to the executed instruction nodes. This equation is simply the appropriate logical statement of each executed instruction node ANDed together to generate the output value 122o of the connected component 122. Rule tables, as given in Table 1 and Table 2, are then used to parse this equation to determine if the active input signal 120 is a required signal for the output value 122o. If the active input signal 120 is a required signal, then the output signal 122o is an active output signal 130. Hence, if the active input signal 120 is not within the equation, then the output signal 122o is not an active output 130. The local start time 130y of a found active output signal 130 is the execution time at which the active output signal 130 obtains its value from the equation. This is typically the reference time 124, or a slightly later time due to propagation delays.

115: If the reference time 124 has exceeded the local stop time 120z, has exceeded the global stop time 38z, or advanced past a point where the active input signal 120 undergoes yet another value change, then go to step 116. Otherwise, advance the reference time 124. Typically, this is done by looking for any input signals 122i of the connected component 122 that undergo a value change, and moving the reference time 124 forward to that time where the value change occurs. Often, however, components will have initial conditions that must be satisfied before other instruction nodes are executed. Such a node is termed an entry-point node. In the event that the connected component 122 has such an entry-point node, then the reference time 124 must also be advanced to a time where the entry-point node is satisfied.

116: If all of the connected components 122 have been considered, then go to step 117. Otherwise, set the reference time 124 back to the local start time 120y, select the next connected component 122 that has not been considered, and go back to step 113.

117: Inform the forward search engine 100 of every active output signal 130 found. The local stop time 130z of each found active output signal 130 is typically the global stop time 38z. However, if the associated active input signal 120 underwent another state change after the local start time 120y, then the local stop time 130z may be the time at which this state change occurs.

The forward search engine 100 then adds every found active output signal 130, as presented in step 117, to the forward active signals list 100s, and each connected component 122 whose output 122o is one of the found active output signals 130 is added to the forward active components list 100c. The local start time 130y and local stop time 130z of each found active output signal 130 is also saved in the forward active signals list 100s. Each found active output signal 130, and associated local start and stop times 130y and 130z, is then used as an active input signal 120 in a subsequent iteration of the forward search algorithm 110 by the forward search engine 100.

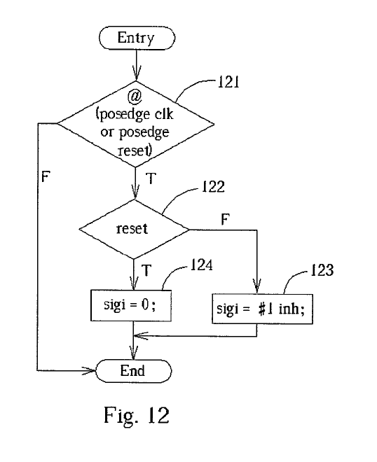

Using the example HDL code 38c of FIGS. 7A to 7C, consider the signal inh as the start signal 38a, with 60 ns as the start time 38y where inh transitions from a zero to a one, as shown in FIG. 10. The stop time 38z is taken as 210 ns, with outg, outh and outf all as the stop signals 38b. The forward search engine 100 passes the start signal inh as the active input signal 120 to the forward search algorithm 110, with a local start time 120y of 60 ns, and a local stop time 120z of 210 ns. As the first step 111 of the forward search algorithm 110, the circuit connection graph 40n is parsed, as given in FIG. 8, yielding components C12, C10 and C8 as the connected components 122 of the active input signal inh. In the circuit connection graph 40n of FIG. 8, the components C1 to C12 are represented by boxes, or by familiar logic symbols. At step 112, it may be assumed that component C12 is taken as the first connected component 122 to be considered. At step 113, with the reference time 124 being set to the local start time 120y of 60 ns, forward inference is performed. Please refer to FIG. 12, which illustrates the statement tree 50t for component C12. Conditional instruction node 121 is an entry-point instruction node 121 that must first be satisfied for anything else to happen, as far as component C12 is concerned. In particular, the entry-point node 121 requires that either the clk signal or the reset signal have a rising edge. At the execution time of 60 ns, however, neither of these signals has a rising edge. At a time of 90 ns, however, the clk signal goes from zero to one, as shown in FIG. 10, which satisfies the entry-point node. The reference time 124 is thus advanced to 90 ns. The next instruction node 121 is also a conditional instruction node 121, checking to see if the reset signal is a logical one. If so, execution passes on to assignment instruction node 123. Otherwise, execution passes on to assignment instruction node 124. At the reference time 124 of 90 ns, reset is equal to a logical zero. Forward inference thus determines that assignment instruction node 123 must be executed. This finishes the execution path of component C12 at the reference time of 90 ns, yielding instruction nodes 121, 122 and 123 as the executed instruction nodes of the execution path. At step 114, an equation is generated by ANDing together logical statements derived from all of the executed instruction nodes, yielding:

sigi=(posedge clk|posedge reset)&(!reset)&(#1 inh) Eqn.1

The simple nature of Boolean math enables both the conditions and value of the output signal sigi 122o to be determined by a single equation. The last term (#1 inh) of Eqn.1 actually sets the value of output signal sigi 122o. The symbol “#1” indicates a 1 ns propagation delay before assignment takes affect. The other terms are what is required to be true for the (#1 inh) assignment to take place. In particular, note the term (!reset), the symbol “!” indicating the logical NOT operator. Because the conditional instruction node 122 evaluated to false at the reference time of 90 ns, this term must be logically inverted to correctly indicate conditions that were present in the execution path. Eqn.1 is then evaluated using Tables 1 and 2. Note that at 91 ns, output signal sigi 122o is a logical one, and so, by Table 2, every term in Eqn.1 is a required term. Consequently, the terms (input signals 122i) “!reset” and “#1 inh” are both required signals. Thus, the active input signal inh 120 is a required signal, and so at a time of 91 ns (due to the 1 ns propagation delay), the output signal sigi 1220 becomes an active output signal 130. At step 115, the reference time 124 may be advanced, but it should be noted that at each other valid entry-point time, all other input signals 122i are the same. There is thus no need to perform any further forward inference. Further, as the active input signal 120 does not change after the local start time 120y of 60 ns, the local stop time 130z of the active output signal sigi 130 would be set equal to the global stop time 38z of 210 ns. It should further be noted that it is sometimes possible for the execution path to contain no assignment node. In effect, the execution path will simply contain conditional instruction nodes that finally cause nothing to happen. In this case, it is assumed that there are no active output signals 130 for the connected component 122.

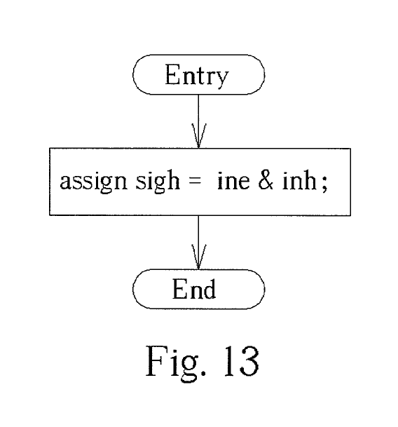

At step 116, the next connected component 122 is considered, which we may assume is connected component C8. The reference time 124 is set back to 60 ns, and the forward search algorithm 110 returns to step 113. The statement tree 50t for component C8 is illustrated in FIG. 13, which is a continuous statement given by:

sigh=ine&inh

This statement is triggered at any time when one of the terms on the right hand side of the equation undergoes a value change. Note that there is no entry-point instruction node for C8, but simply one assignment instruction node that also yields the Boolean equation that is evaluated to determine if the active input signal inh 120 is a required signal. In this case, though, the other input signal ine 122i remains zero from the start time 38y of 60 ns to the stop time 38z of 210 ns. According to Table 2, then, active input signal inh 120 is not a required signal for sigh, and so sigh is not an active output 130. Again, forward inference needs only to be performed once, as input signal ine 122i does not change over the start and stop times 38y and 38z.

With regards to the connected component C10 122, referencing line 71 of the sample HDL code 38c in FIG. 7C, it is clear that connected component C10 122 has an entry-point node that is the same as that for connected component C12 122, and hence the reference time 124 must be advanced to 90 ns. However, at 90 ns, and thereon until the stop time 38z, the output value of connected component C10 122 is determined by line 76 of the HDL code 38c. The equation that gives the value of the output signal sigg 122o from 90 ns is thus:

sigg=(posedge clk|posedge reset)&(!reset)&(controlc&&!controld)&(#1 ini)

The active input signal inh 120 is not anywhere present in the above equation, and so the output signal sigg 122o of connected component C10 122 is not an active output signal 130. Connected component C10 122 is therefore not an active component.

Once the forward search algorithm 110 has finished with the start signal 38a, i.e., inh, the forward search engine 100 adds the found active output signals 130 and associated local start 130y and local stop 130z times to the forward active signals list 100s. Similarly, the connected components 122 whose outputs 122o are the found active output signals 130 are added to the forward active components list 100c. In the above example, then, the active output sigi 130 with a local start time 130y of 91 ns and a local stop time 130z of 210 ns is added to the forward active signals list 100s, and the associated component C12 is added to the forward active components list 100c.

Using the found active outputs 130 of the previous iteration, the forward search engine 100 calls the forward search algorithm 110 for a subsequent iteration. Consider, for example, the found active output signal sigi. Active output signal sigi is passed to the forward search engine 110 as the active input signal 120 with a local start time 120y of 91 ns, and a local stop time 120z of 210 ns, which are the associated local start and stop times of the active signal sigi. Step 111 of the forward search algorithm 110 finds a single connected component C3 122. The execution path of connected component C3 122 at the local start time 120y of 91 ns (which is the reference time 124), as performed by step 113, is a single statement given by:

sige=sigi&ini Eqn. 2

At 91 ns, the active input sigi 120 is a logical one. More importantly, the output sige 122o at 91 ns is also a logical one. Hence, both input signals sigi 120 and ini 122i are required signals, according to Table 2. Since the active input signal sigi 120 is a required signal, the output signal sige 122o is considered an active output signal 130. There is no indicated propagation delay, so sige becomes an active output signal 130 at 91 ns, the local start time 130y. Further, neither sigi nor ini change after 91 ns, so no more forward inference is required, and the local stop time 130z of active output signal sige 130 is given as the global stop time 38z of 210 ns. At step 117, the forward search algorithm 110 presents sige as an active output signal 130 to the forward search engine 100, which then adds sige to the forward active signals list 100s, and component C3 to the forward active components list 100c.

In yet another iteration of the forward search algorithm 110 by the forward search engine 100, the active output signal sige will be used as an active input signal 120, with a local start time 120y of 91 ns, and a local stop time 120z of 210 ns. In step 111, components C4 and C6 are found as the connected components 122 of the active input signal sige 120. Using component C4 as yet another example, in step 113 forward inference is performed. FIG. 9 illustrates the statement tree 50t for connected component C4 122. In particular, connected component C4 122 has an entry-point node 131 that must first be satisfied, either by a rising edge of the clk signal, or a rising edge of the reset signal. Forward inference looks forward from the local start time 120y of 91 ns to find an appropriate time that satisfies the entry-point node 131, which is at 150 ns, as shown in FIG. 10. The reference time 124 is thus set to 150 ns. The entry-point node 131 points to another conditional instruction node 132 as the next to be executed, which simply tests if the reset signal is a logical one. At the reference time 124 of 150 ns, the reset signal is a logical zero, and so execution passes to conditional instruction node 133, which tests the value “controlc && controld”, i.e., if signal controlc is a logical one, and signal controld is a logical zero. At 150 ns, this evaluates to true, and so execution passes on to assignment instruction node 134. The execution path at the reference time 124 of 150 ns thus includes the executed instruction nodes 131, 132, 133 and 134. ANDing the logical statements of executed instruction nodes 131, 132 and 133 to the left-hand side of the logical statement of executed instruction node 134 (with appropriate inversion where required by a false conditional evaluation) yields the equation:

sigb=(#1sige)&(controlc&&!controld)&(!reset)&(posedge clk|posedge reset) Eqn.3

At 151 ns, output signal sigb 122o is a logical one, and thus, by Table 2, every term in Eqn.3 is required. In particular, then, the active input signal sige 120 is required, and so the output signal sigb 122o is an active output signal 130, with a local start time 130y of 151 ns. At step 115, it can be determined that no more forward inference is required, as no other input values 122i beyond clk change after 150 ns. Active output signal sigb 130 is thus presented to the forward search engine 100, with a local start time 130y of 151 ns, and a local stop time 130z of 210 ns.

One of the final iterations of the forward search algorithm 110 will be given the signal sigb as an active input signal 120, with the local start time 120y of 151 ns. The connected component 122 of sigb is simply component C7, which is an AND gate having a continuous assignment given by:

outf=siga&sigb Eqn.4

At the local start time 120y of 151 ns, forward inference step 113 and active signal determination step 114 conclude that outf is not an active output 130. This is simply due to Table 2, since, at 151 ns, output signal outf 122o is zero, the active input signal sigb 120 is one, and the other input signal siga 122i is zero. Table 2 indicates that sigb is not a required signal, and so outf is not an active output 130. However, at step 115, by referencing the simulation results 38s, it is noted that the other input signal siga 122i undergoes a state change at 210 ns. The reference time 124 is thus advanced to 210 ns. At this time, outf is a logical one, and so, by Table 2, sigb is a required signal. Output signal outf 122o is thus an active output signal 130, with a local start time 130y of 210 ns, and a local stop time 130z of 210 ns.

The active output signal outf 130 is also one of the stop signals 38b. The forward search engine 100 thus does use signal outf as an active input signal 120 for another iteration of the forward search engine 110. Eventually, all successive iterations of the forward search algorithm 110 will reach either a stop signal 38b, or the global stop time 38z. The forward search engine 100 will then conclude that the complete active path of the start signal (or signals) 38a has been traversed. Program code 38p then calls a display engine 300 to provide the forward active signals 100s and the forward active components 100c to the user, either by way of the display 34d or the printer 34p. The display engine 300 uses the forward active signals 100s, the forward active components 100c and the circuit connection graph 40n to graphically present the forward active path to the user.

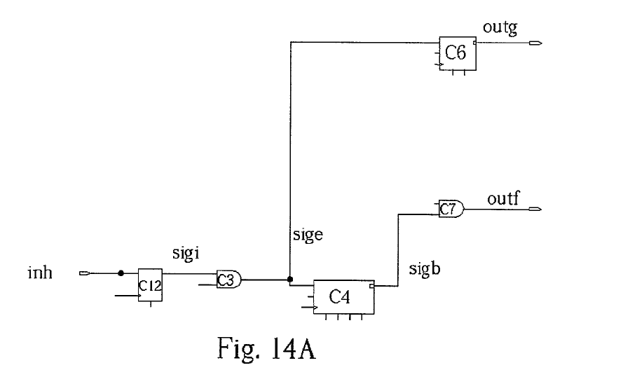

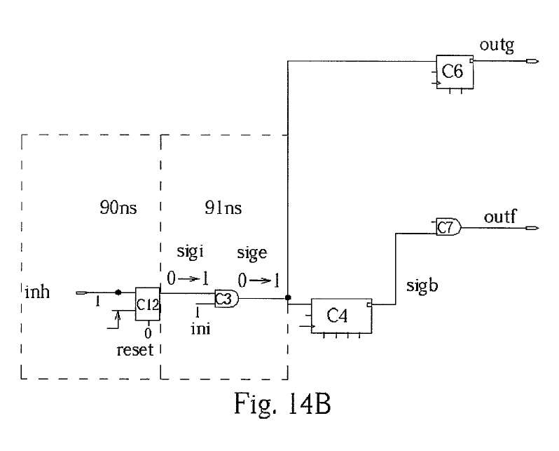

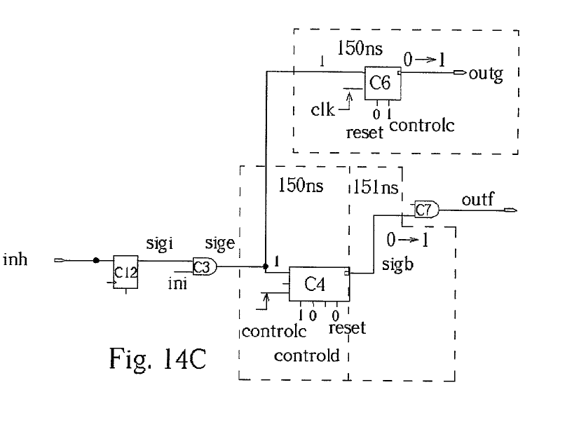

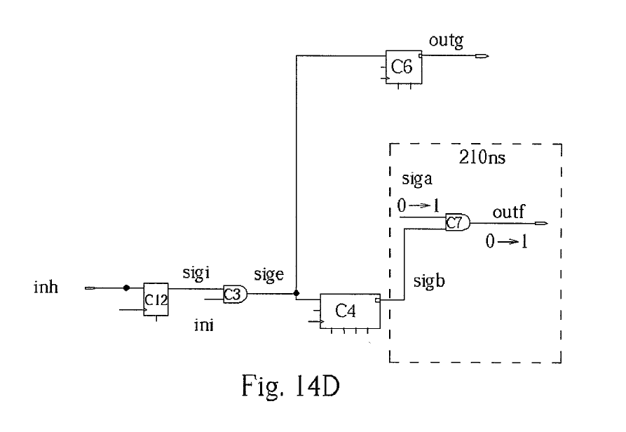

In the broadest manner, the entire extracted active path, as determined from the forward active signals 100s and the forward active components 100c, can be presented to the user, with non-active signals and components left out from the presentation. Such a display is shown in FIG. 14A for the example start signal inh that was enumerated at some length above. However, a more useful device is to present the time-active dynamics of the extracted active path. Typically, the extracted path has several break point times, where one portion is active while another portion has not yet become active. The present invention enables the user to scroll through the break point times, and see how different regions of the active path become active at their respective local start times 130y. Furthermore, by utilizing the associated equation that is used to determine that an output is active, other required signals can be determined, and their states at the local start time 130y shown to the user. In general, break point times are determined by the start times 130y of the active signals. Active signals that have the same local start time (taking into account propagation delays) are considered to be part of the same break point active region. For example, in FIG. 14B, the first break point of the extracted active path shown in FIG. 14A is indicated by a dashed enclosing rectangle. Everything within the dashed rectangle is drawn in a special manner, as in a highlighting color, or in bold lines, so that the break point active region is clearly defined to the user. Utilizing Eqn.1, and Tables 1 and 2, the display engine 300 determines that the rising value of the clk signal, the reset signal and the active input signal inh 120 are all required. The display engine 300 also learns of the Ins propagation delay, and so divides input values 122i, 120 from output values 130 by a dashed line, the execution time on the left side of the dashed line indicated, as well as that on the right side of the dashed line, i.e., 90 ns and 91 ns, respectively. The value of each required input signal 122i is then indicated, as well as state changes of the required input signals 122i, if any. Hence, the rising edge of the clk input is shown for component C12, and the logical zero value of the reset signal is also shown. The user is aware that this is at execution time of 90 ns, due to the dashed line. On the 91 ns side of the dashed line, the transition of active output signal sigi 130 is shown, as well as the transition of active output sige 130. The required input signal ini 122i, as obtained from Eqn.2, with a value of one, is also indicated. The remainder of the active path, such as components C4 and C7, and active outputs sigb and outf, are drawn in a normal manner to indicate that they are not yet active at 90 ns and 91 ns.

By utilizing the input equipment 32, the user may select the next break point time of the active path, the display of which is presented in FIG. 14C. The dashed rectangle encloses the break point region for the execution time of 150 ns and 151 ns. By utilizing Eqn.3, the display engine 300 determines that the input signals 122i sige, controic, controld, reset, and the rising edge of clk are all required input signals 122i. The values and state changes of these required input signals 122i are presented. The active output signal sigb 130, with a local start time 130y of 151 ns, is also indicated, changing from a zero to a one. As before, relevant signals and components within the dashed rectangle are drawn in a distinctive manner.

The third and final break point of the above example is presented in FIG. 14D, which occurs at an execution time of 210 ns. Required signals siga and sigb, derived from Eqn.4, are shown with their respective values, as is the transition of siga from zero to one, and the corresponding transition of active output signal outf 130 from zero to one.

Not only, then, does the program code 38p extract forward active paths, but with the aid of the display engine 300, the program code 38p is able to present various execution time views of the active path, better enabling an engineer to comprehend the dynamics of the circuit as represented by the HDL code 38c. With the input equipment 32, the engineer may switch between different break point times of an extracted active path, noting the required signals at each break point time, and the values these required signals have, that causes the value change of the start signal 38a to propagate through the circuit and affect the stop signal 38b.

Finally, the user I/O routines 38i may be used to save the forward active signals 100s and the forward active components 100c as a file or files in an implementation-dependent manner to permanent storage in the memory 38, or on the removable media 34r. The method of doing so is trivial to those suitably skilled in the art. Such files may be read in by the program code 38p so that a user may once again view, and perhaps augment, the forward active signals 100s and the forward active components

In addition to the forward search engine 100, the program code 38p according to the present invention also provides a backward search engine 200. Whereas the forward search engine 100 begins with a start signal 38a and a start time 38y and works forward in the execution time to the stop signal 38b and stop time 38z, the backward search engine 200 begins with the stop signal 38b and stop time 38z and works backwards in execution time towards the start signal 38a and start time 38b to traverse and extract the active path. In doing so, the backward search engine 200 obtains active components of the extracted active path that are saved in a backwards active components list 200c. Similarly, all active signals of the extracted active path are saved in the backward active signals list 200s, as well as the corresponding local start and stop times of the active signals.

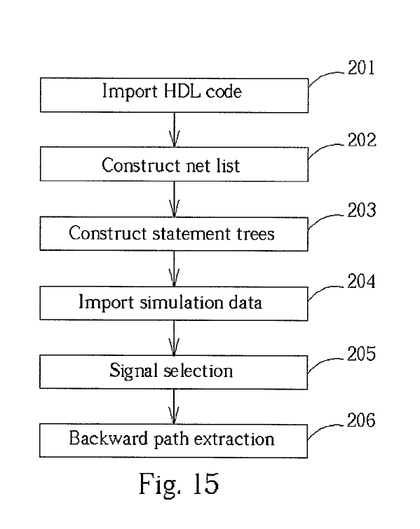

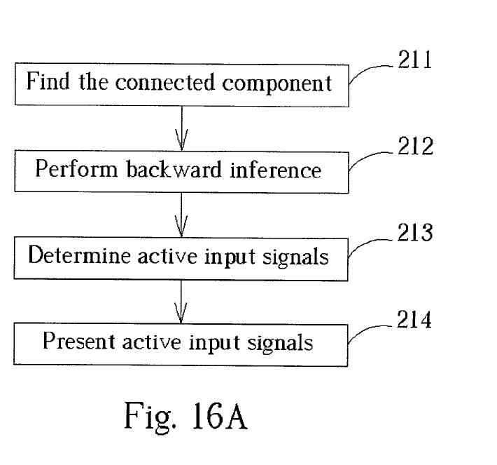

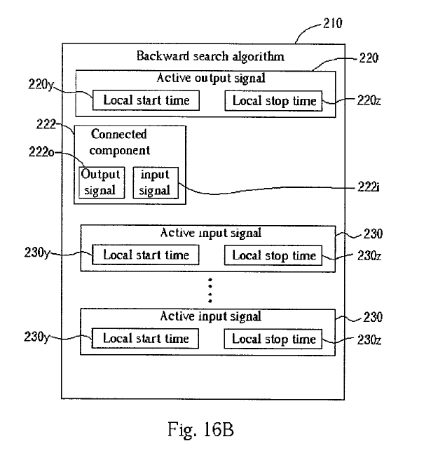

Please refer to FIG. 5. FIG. 15 is a flow chart for the backward search engine 200. The program flow for the backward search engine 200 is much like that for the forward search engine 100, except that at the final step a backward search algorithm 210 is called instead of the forward search algorithm 110. Hence, at step 201, the user I/O routines 38i are utilized to obtain the HDL code 38c. At step 202, the connection list parser 40 is called to generate the circuit connection graph 40n from the HDL code 38c obtained from step 201. At step 203, the statement tree parser 50 is called to build the statement trees 50t for the HDL code 38c. At step 204, the user I/O routines 38i are utilized to obtain the simulation results 38s for the HDL code 38c. Or, again, the circuit simulator 39 may be run, with the input vectors 39i and the HDL code 38c, to directly obtain the simulation results 38s. In step 205, the user I/O routines 38i are used to obtain the stop signal 38b, the corresponding stop time 38z, the start signal 38a and the corresponding start time 38y. As with the forward search engine 100, default values may be used when any value is not explicitly stated by the user. The stop time 38z should be a time at which the stop signal 38b undergoes a value change, and the program code 38p may adjust the stop time 38z to a value that most closely corresponds to this condition. Finally, in step 206, the backward search engine 200 iteratively calls the backward search algorithm 210 to traverse active path of the stop signal 38b. Please refer to FIG. 16A and FIG. 16B. FIG. 16A is a flow chart of the backward search algorithm 210, the steps of which are described below. FIG. 16B is a simple block diagram of the backward search algorithm 210. For the first iteration of the backward search algorithm 210, the backward search engine 200 uses the stop signal 38b as a provided active output signal 220, and stop time 38z as a local start time 220y and a local stop time 220z of the active output signal 220. With this data, the backward search algorithm 210 provides active input signals 230 corresponding to the given active output signal 220. Each found active input signal 230 has corresponding local start and stop times 230y and 230z. These found active input signals 230, and their corresponding local start 230y and stop 230z times, are then used in subsequent iterations of the backward search algorithm 210 to further traverse the active path.

211: The circuit connection graph 40n is used to find the component that is directly connected to the active output signal 220, termed a connected component 222, and which has the active output signal 220 as an output signal 222o. There should only be one such connected component 222, as the active signal 220 under consideration is an output signal. Otherwise, the active signal 220 will be one of the start signals 38a, and the backward trace algorithm jumps to step 214. The connected component 222 is an active component, as one of its output signals 222o is the active output signal 220. Hence, this active component 222 will have at least one input signal 222i that is an active input signal 230, unless the effective start time 230y of the active input signal 230 is before the global start time 38y, which is a termination condition for the backward search algorithm 210.

212: For the connected component 222, obtain the associated statement tree 50t. Then, index into the simulation results 38s according to the local start time 220y to determine the execution path of the connected component 222 immediately at and before the local start time 220y. In effect, this traces backwards the steps that the circuit simulator 39 took to generate the value of the active output signal 220 at the local start time 220y. Each instruction node that was executed to generate the value of the active output 220 of the connected component 222 is noted, and is termed an executed instruction node.

213: Using the executed instruction nodes found in step 212, an equation is generated that equals the output value of the active output signal 220 according to the executed instruction nodes. This equation is derived from the appropriate logical statement of each executed instruction node ANDed together to generate the output value of the active output signal 220 at the local start time 220y. Rule tables, as suggested in Table 1 and Table 2, are then used to parse this equation to determine the required input signals 222i for the value of the active output signal 220. The active input signals 230 are such required input signals 222i. The local start time 230y of an active input signal 230 is the latest execution time that is on or before the local start time 220y of the active output signal 220 at which the active input signal 230 undergoes a transition to obtain its value. If the local start time 230y is before the global start time 38a, then the active input signal 230 is discarded. The local stop time 230z of an active input signal 230 is the earliest execution time after the local start time 230y at which the active input signal 230 undergoes a state change. If this value exceeds the global stop value 38z, then the local stop time 230z is simply set equal to the global stop value 38z

214: Inform the backward search engine 200 of every active input signal 230 found.

The backward search engine 200 saves the found active input signals 230, and the associated local start 230y and stop 230z times, in the backward active signals list 200s. The backward search algorithm 210 may optionally also inform the backward search engine 200 of the connected component 222, which is then added to the backward active components list 200c. Alternatively, the backward search engine 200 may use the backward active signals 200s and the circuit connection graph 40n to find the associated active components itself, and add the active components to the backward active components list 200c; such active components being any component with an output that is one of the signals in the backward active signals list 200s.

Consider, for example, the sample HDL code 38c given in FIG. 7A to FIG. 7C, with simulation results 38s as presented in FIG. 10. To provide a working example of the backward search engine 200, assume that the stop signal 38b is outf, with a stop time of 210 ns. Further assume that all signals on the left-hand side of the net graph 40n as depicted in FIG. 8 are all start signals 38a, with a start time of 60 ns. The signals clk and reset, however, are ignored, and are not considered active input signals 230 for the present example. Explicitly ignoring signals is a feature which may be built into both the forward search engine 110 and the backward search engine 210. Permitting the user to ignore certain signals helps to prevent the active path from fanning too excessively, and thus avoids encompassing unnecessary components.

In the first iteration of the backward search algorithm 210 by the backward search engine 200, signal outf is provided as the active output signal 220, and the stop time 38z is provided as both the local start time 220y and the local stop time 220z. In step 211, the backward search algorithm references the circuit connection graph 40n with respect to the active output signal outf 220, and finds component C7 as the connected component 222. The statement tree 50t for connected component C7 is, as noted previously for the forward search algorithm 110, simply a single continuous assignment given by Eqn.4. At the local start time 220y of 210 ns, the output value of outf is a logical one. Hence, by the rules of Table 2, the input signals 222i of the connected component 222, siga and sigb, are both required signals. Hence, siga is an active input signal 230, and sigb is also an active input signal 230. The local start time 230y of active input signal siga 230 is 210 ns, as this is the time at which siga obtains its value of a logical one, and this time satisfies the condition of being on or before the local start time 220y of the active output signal 220. The local stop time 230 of siga is simply the global stop time 38z, i.e., 210 ns. For active input signal sigb 230, referencing the simulation results 38s, the backward search algorithm determines that 151 ns is the latest execution time on or before the local start time 220y at which sigb went to a logical one. The local start time 230y of active input signal sigb 230 is thus 151 ns. The local stop time 230z of sigb is 210 ns. The two active input signals 230, siga and sigb, are then presented to the backward search engine 200. The backward search engine adds siga and sigb to the backward active signals list 200s, and adds component C7 to the backward active components list 200c.

Subsequently, the next two iterations of the backward search algorithm 210 will be respectively provided siga and sigb, each with its respective local start and stop times, as the active output signal 220. As an example of this subsequent iteration, sigb is considered. The backward search engine 200 provides sigb as the active output signal 220 to the backward search algorithm 210, with a local start time 220y of 151 ns, and a local stop time 220z of 210 ns. In step 211, the connected component 222 is found to be C4. In step 212, the statement tree 50t for C4 is obtained, which is depicted in FIG. 9. At the local start time 220 of 151 ns, sigb has a value of one. By parsing the statement tree 50t of component C4, the backward search algorithm 210 determines that three assignment instruction nodes are possible for active output signal sigb 220, which are assignment nodes 134, 135 and 136. Assignment node 136, however, does not satisfy the condition that sigb is a logical one, and so is not potentially part of the execution path at the execution time of 151 ns. Assignment instruction nodes 134 and 135 are both possible, however, as the signals sige and sigg are both a logical one at 150 ns. Note that the symbol “#1” informs the backward search algorithm 210 that the reference time (i.e., the local start time 220y) is being pushed back by 1 ns due to propagation delays. Hence, the backward search algorithm 210 considers the values of sigg and sige at 150 ns, rather than at the local start time 220y of 151 ns. To test which of the instruction nodes 134 and 135 is actually part of the execution path, backward inference requires tracing backwards, following and evaluating links to previous instruction nodes. For assignment instruction node 135 to be part of the execution path, conditional instruction node 138 must evaluate to true. However, at an execution time of 150 ns, signal controle is a zero, according to the simulation results 38s. Hence, assignment instruction node 135 is not part of the execution path, which leaves assignment node 134 as the only possible candidate. In theory, any further evaluations for backwards tracing could be ignored, and instead the execution path could simply be found by directly tracing back from instruction node 134 up to entry-point node 131, working against the process flow direction of the arrows. In practice, though, it is better to verify that each instruction node is properly part of the execution path. Hence, logical statement “controlc&&!controld” of conditional instruction node 133 is verified to evaluate to true at 150 ns, which it does. Logic statement “reset” of conditional instruction node 132 is verified to evaluate as false at 150 ns, which it also does, as the signal reset is a logical zero at 150 ns. Finally, the rising edge of the signal clk at 150 ns satisfies the entry-point node 131. Back tracing at the local start time 220y of 151 ns thus reveals the execution path that produces that output value of the active output signal sigb 220, yielding executed instruction nodes 131, 132, 133 and 134. The equation derived from these executed instruction nodes is presented in Eqn.3. Using Tables 1 and 2, the required signals are found to be sige, controlc, controld, reset and clk. However, reset and clk are ignored, and so the active input signals 230 are finally sige, controic, and controld. The local start time 230y of active input signal sige 230 is 91 ns, as this is the latest execution time prior to the local start time 220y at which sige obtains a logical one value. Signal controld, however, does not undergo any state change on or after the global start time 38y. The local start time 230y of controld would thus be before the global start time 38y. Signal controld is thus discarded as not being an active input signal. Signal controic, however, undergoes a state change at 60 ns, which is equal to the global start time 38y. The local start time 230y of controlc is thus 60 ns, which satisfies the requirement of being on or before the global start time 38y. Signal controlc is therefore considered an active input signal 230. Signal sige undergoes a state change at 91 ns, and so sige is considered an active input signal 230 with a local start time of 91 ns, as this is before the global start time 38y of 60 ns. As active input signal sige 230 does not change after the local start time 230y, the local stop time 230z is simply the global stop time 38z, i.e., 210 ns. Similarly, the local stop time 230z of signal controlc is 210 ns. Finally, in step 214, the active input signals sige and controlc 230 are presented to the backward search engine 200. The backward search engine adds sige and controlc to the backward active signals list 200s, and component C3 to the backward active components list 200c.

Active input signal controlc is one of the start signals 38a, and so is not used in a subsequent iteration of the backward search algorithm 210. Another iteration of the backward search algorithm 210, using sige as the active output signal 220 with a local start time 220y of 91 ns and a local stop time 220z of 210 ns, will find that signals ini and sigi are both active input signals 230 (as both are required signals for the logical one output value of AND gate C3, according to Table 2, at the local start time 220y of 91 ns), with ini having a local start time 230y of 60 ns, and sigi having a local start time 230y of 91 ns. Note that the local start time 230y of active input signal sigi 230 satisfies the condition of being on or before the local start time 220y of the active output signal sige 220.

Active input signal ini is one of the start signals 38a, and so is not used for another iteration of the backward search algorithm 210, though it is added to the backward active signals list 200s. Active input signal sigi, however, is added to the backward active signals list 200s and is also used as the active output signal 230 in a subsequent iteration of the backward search algorithm 210, which, using the local start time 220y of 91 ns, back traces to find executed instruction nodes 121, 122 and 123 (as shown in FIG. 12), and from which is generated Eqn.1. The required signals of Eqn.1 are reset, clk and inh. However, only inh is considered, as reset and clk have been specified as being signals to ignore. Signal inh undergoes a state change at 60 ns, which is on the global start time 38y, and so within the execution bounds of the start time 38y and the stop time 38z. Signal inh is thus considered an active input signal 230, with a local start time of 60 ns. Active input signal inh is a start signal 38a, and so is not used in a subsequent iteration of the backward search algorithm 210, though it is added to the backward active signals list 200s.

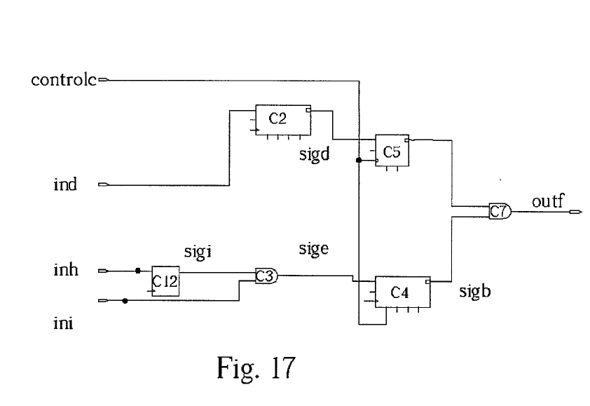

Once the backward search engine 200 has completed all iterations of the backward search algorithm 210, the program code 38p passes the backward active components list 200c and the backward active signals list 200s to the display engine 300 for presentation to the user. As described earlier for forward searching, the display engine 300 may present the entire active path as an undifferentiated whole. Such an output is illustrated in FIG. 17, which shows the backwards extracted active path for stop signal outf, as discussed in example above. Alternatively, the display engine 300 may highlight break point regions within the active path, while permitting the user to change the break point time to select different break point regions to be highlighted. Of course, the break point regions of a backwards active path are determined in the same manner as those for a forward active path: that is, by utilizing the local start and stop times of the active signals. Active signals 200s and components 200c associated with a local start time are presented in a special manner, whereas all others are presented in a normal manner. The required signals in a break point region and their values, as obtained when determining that a signal is active, are also presented.

It should be noted that, for break point display, since the display engine 300 must know the required signals of the active output of a component, while performing active path extraction, by either the forward or backward method, it may be desirable to save the required signals of each active signal, beyond merely saving the local start and stop times of the active signal. In this manner, associated required signal information is readily available to the display engine 300 for each active signal, rather than necessitating additional processing to re-extract information that had already been previously found. The required signals for each active signal may be stored in the forward active signals list 100s, in the forward active components list 100c, in the backward active signals list 200s, or in the backward active components list 200c. Alternatively, the required signals may be stored in a separate list of their own. For example, from Eqn.3, the required signals for sigb at 150 ns/151 ns are sige, controlc, controld, reset and clk. The states, and any transitions, of these signals are then presented in the break point active region associated with the 150 ns/151 ns execution break point time. When the active signal sigb is saved with its local start time of 151 ns, it may also be desirable, then, to save references to the required signals sige, controlc, controld, reset and clk. Any referenced required signal of an active output signal are presented with their values at the break point time in the break point active region.

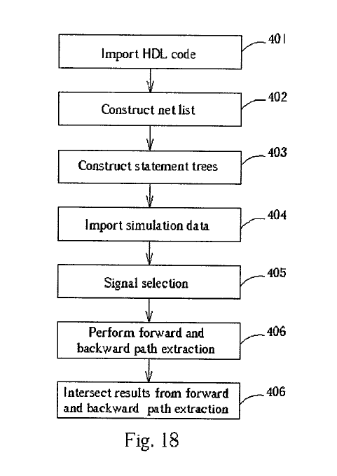

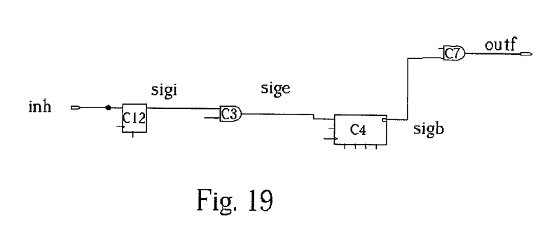

Another extremely useful active path extraction tool is the point-to-point search, which is implemented by a point-to-point search engine 400, as shown in FIG. 5. Please refer to FIG. 18, which is a flow chart for the point-to-point search engine 400. The initial steps of the point-to-point searching engine 400 are much like those for the forward search engine 100, and the backward search engine 200. That is, at step 401, using the user I/O routines 38i to obtain the HDL code 38c; at step 402, using the connection list parser 40 with the HDL code 38c to obtain a circuit connection graph 40n of the HDL code 38c; at step 403, using the statement tree parser 50 to obtain statement trees 50t of the HDL code 38c; at step 404, obtaining the simulation results 38s for the HDL code 38c, and finally at step 405, calling the user I/O routines 38i to obtain a start signal 38a and associated start time 38y, and a stop signal 38b with an associated stop time 38z. In step 406, however, the point-to-point search engine 400 iteratively calls both the forward search algorithm 110 and the backward search algorithm 210. The forward search algorithm 110 is iterated to generate the forward active path of the start signal 38a, which is then held in the forward active components list 100c, and in the forward active signals list 100s. The backward search algorithm 210 is iterated to generate the backward active path of the stop signal 38b, which is then held in the backward active components list 200c, and in the backward active signals list 200s. Once the forward and backward active paths have been fully traversed, the point-to-point search engine 400 then calls an intersection engine 410. The intersection engine 410 looks for all components that are common to both the backward active components list 200c and the forward active components list 100c, and saves these common components in an intersected active components list 400c. Similarly, the intersection engine 410 looks for all signals that are common to both the backward active signals list 200s and the forward active signals list 100s, and saves these common signals in an intersected active signals list 400s, as well as saving the local start and stop times of the common signals, and any associated required signals of the common signals, if present. The point-to-point search engine 400 thereby generates an active path, as represented by the intersected active signals 400s and the intersected active components 400c, that connects the start signal 38a to the stop signal 38b. The program code 38p then calls upon the display engine 300 to display the active path as found by the point-to-point search engine 400. The display may be a general display of the extracted active path, or a break point display of the active path. FIG. 19 illustrates an example point-to-point search, using signal inh as the start signal 38a, signal outf as the stop signal 38b, 60 ns as the start time 38y and 210 ns as the stop time 38z. Note that the forward portion of this search is shown in FIG. 14A, and the backward portion of the search is shown in FIG. 17. FIG. 19 is clearly the intersection of FIG. 14A and FIG. 17, which is the result of the intersection engine 410.

In the above description of the search engines 100, 200 and 400, it should be understood that a plurality of start signals 38a and stop signals 38b may be used as initial starting conditions for the search engine. The above examples used a single start or stop signal simply for the sake of simplicity of discussion. Nevertheless, it must be clear to one in the art that multiple start and end point signals can be used. Also, the forward search algorithm 110, and the backward search algorithm 210, could both be implemented in a recursive manner. If this is done, then only a single call to the algorithm is required by the associated engine 100, 200. The algorithm will iterate itself, recursively using found output values as inputs for a subsequent iteration, until end-point conditions are reached. Both the forward search algorithm 110 and the backward search algorithm 210 utilize the circuit connection graph 40n and statement trees 50t, which are depicted as separate files in this preferred embodiment. However, there is a direct, computable correlation between the circuit connection graph 40n and HDL code 38c, as well as between the statement trees 50t and HDL code 38c. Hence, it is not strictly necessary to have separate files for statement trees 50t and circuit connection graphs 40n. The HDL code 38c could itself serve as the statement trees 50t and circuit connection graph 40n. Hence, simple variations of the forward search algorithm 110 and the backward search algorithm 210 would simply provide for code that extracts connection information and execution flow information from the HDL code 38c on an as-needed basis, thus avoiding dedicated circuit connection graphs 40n and statement trees 50t. Nevertheless, such code would then simply be the statement tree parser 50 and the connection list parser 40 embedded within the search engine 100, 200, in effect simply moving program code from one location to another, while maintaining effectively the same functionality. Pre-parsing is considered superior, though, as it has the potential for greater overall execution speeds. As such, pre-parsed circuit connection graphs 40n and statement trees 50t are depicted in the preferred embodiment.

Active paths as extracted by the forward search engine 100, backward search engine 200 and point-to-point search engine 400 may all be presented to the user by the display engine 300 in the break-point manner as previously described. It is further possible for the display engine 300 to animate the break point regions, the animation sequence going in order of the local start times of the active signals and active components. For example, referring back to the active path presented in FIGS. 14A to 14D, to present an animated sequence the display engine 300 will first present an image as given by FIG. 14B onto the display 34d. After a predetermined action on the part of the user via the input equipment 32, such as a key press of the keyboard 32k, the display engine 300 clears this image and immediately presents another image as given in FIG. 14C. After another key press, the displayed image is cleared and an image as provided by FIG. 14D is presented. The process can be looped, repeatedly returning to the first image and sequentially advancing to the last image. The display engine 300 uses the local start times to determine which break point region is to be high lighted, steadily advancing the break point times with each key press.

In contrast to the prior art, the present invention provides path extraction engines that can obtain an active path based upon a start signal, a stop signal, or find the active path between a start and stop signal by using only HDL code and simulation results. A unique break point display option enables a user to selectively view the various regions of the path that become active at the same time. Additionally, required signals, their values and state changes are also presented. The complete dynamics of a signal change, and how such a change propagates through a circuit to affect other components, are thus made readily available to the user.

Those skilled in the art will readily observe that numerous modifications and alterations of the device may be made while retaining the teachings of the invention. Accordingly, the above disclosure should be construed as limited only by the metes and bounds of the appended claims.

What is claimed is:

1. An active path extraction method for hardware description language (HDL) code in a computer system, the computer system comprising user input equipment for accepting input from a user, and user output equipment for providing output to the user, the HDL code being used to represent an electronic circuit having a plurality of components, each component having at least an input signal and an output signal, the method comprising:
utilizing the user input equipment to obtain at least a start signal from the user, the at least a start signal being an output signal or an input signal;
utilizing the user input equipment to obtain at least a stop signal from the user, the at least a stop signal being an output signal or an input signal;
utilizing the user input equipment to obtain a start time and a stop time;
obtaining simulation results of the electronic circuit from a simulator that utilizes the HDL code, the simulation results having state changes of the output signals and the input signals;
parsing the HDL code to obtain a circuit connection graph between the at least a start signal and the at least a stop signal, the connection graph comprising components, input signals, and output signals that electrically connect the at least a start signal to the at least a stop signal;
utilizing the simulation results and the HDL code to determine which of the components in the circuit connection graph are active components, an active component being any component in the circuit connection graph having an active output signal, an active output signal being any output signal of any component in the circuit connection graph that obtains a state between the start time and the stop time in response to a state change of the at least a start signal according to an execution path of the HDL code; and
utilizing the user output equipment to provide the active components or the active output signals to the user.

2. The method of claim 1 in which the user output equipment is utilized to provide both the active components and the active output signals to the user.

3. The method of claim 1 wherein the active components are found by iterating a forward search method, the forward search method comprising:
obtaining an active input signal;
utilizing the connection graph to obtain a connected component, the connected component having the active input signal as an input signal of the connected component;
utilizing the HDL code and the simulation results to obtain the execution path of the connected component at an execution time that is between the start time and the stop time; and
utilizing the execution path to determine if an output signal of the connected component is an active output signal of the connected component, wherein the output signal of the connected component is an active output signal of the connected component only if the output signal of the connected component obtains a state in response to a state change of the active input signal;
wherein the active output signal of the connected component is utilized as an active input signal in a subsequent iteration of the forward search method;
wherein the first iteration of the forward search method utilizes the at least a start signal as the active input signal.

4. The method of claim 3 wherein utilizing the execution path to determine if the output signal of the connected component is an active output signal of the connected component comprises:
utilizing the execution path to obtain an equation that generates a value of the output signal of the connected component according to at least an input signal of the connected component, wherein if the active input signal is not within the equation, then the output signal of the connected component is not an active output signal of the connected component; and
parsing the equation to determine if the active input signal within the equation is a required signal for the value of the output signal of the connected component; wherein if the active input signal is a required signal, then the output signal of the connected component is an active output signal of the connected component.

5. The method of claim 4 wherein utilizing the HDL code and the simulation results to obtain the execution path of the connected component at the execution time comprises:
parsing the HDL code corresponding to the connected component to obtain at least an instruction node, each instruction node corresponding to a logical instruction step of the HDL code; and
iteratively substituting simulation results corresponding to a time on or after the execution time into the at least an instruction node according to the at least an instruction node to determine which instruction nodes of the connected component are executed at or after the execution time to obtain the value of the output signal of the connected component, wherein the execution path consists of executed instruction nodes; and
utilizing the execution path to obtain the equation that generates the value of the output signal of the connected component comprises:
linking logical statements derived from each instruction node in the execution path together by a logical AND operator to obtain a Boolean equation that generates the output value of the output signal of the connected component according to at least an input signal of the connected component.

6. The method of claim 5 wherein the at least an instruction node of the connected component includes an entry-point node that must be satisfied before other instruction nodes of the connected component are subsequently executed, and the simulation results at the execution time satisfy the entry-point node.

7. The method of claim 6 wherein the execution time is a simulation time that is closest to the start time.

8. The method of claim 5 wherein the execution time is a simulation time that is closest to a state change of the at least a start signal.

9. The method of claim 3 wherein the active input signal has an associated local input time, and the active output signal of the connected component has an associated local output time that is the earliest simulation time on or after the local input time at which the output signal of the connected component obtains a state in response to a state change of the active input signal; wherein the local output time is utilized as a local input time in a subsequent iteration of the forward search method.

10. The method of claim 9 wherein the execution time is a simulation time on or after the local input time.

11. The method of claim 9 wherein a differentiated active component is provided to the user in a differentiated manner according to the local input time or the local output time of the differentiated active component.

12. The method of claim 11 wherein required signals of the active output signal of the differentiated active component are further provided.

13. The method of claim 12 wherein values of the required signals at the local output time or the local input time are further provided.

14. The method of claim 11 further comprising utilizing the user input equipment to obtain a break point time from the user, and selecting the differentiated active component according to the break point time.

15. The method of claim 9 further comprising an animated display of the active components or active signals according to the local input times or the local output times.

16. The method of claim 3 further comprising adding the connected component to an active component list if the output signal of the connected component is an active output signal, and adding the output signal of the connected component to an active signal list if the output signal of the connected component is an active output signal.

17. The method of claim 1 wherein the active components are found by iterating a backward search method, the backward search method comprising:
obtaining a start-point active output signal;
utilizing the connection graph to obtain a connected component, the connected component having the start-point active output signal as an output signal of the connected component;
utilizing the HDL code and the simulation results to obtain the execution path of the connected component at an execution time that is between the start time and the stop time; and
utilizing the execution path to determine if an input signal of the connected component is an active input signal of the connected component, wherein the input signal of the connected component is an active input signal of the connected component only if the start-point active output signal obtains a state in response to a state change of the input signal of the connected component;
wherein the active input signal of the connected component is utilized as a start-point active output signal in a subsequent iteration of the backward search method;
wherein the first iteration of the backward search method utilizes the at least a stop signal as the start-point active output signal.

18. The method of claim 17 wherein the execution time is a simulation time at which the start-point active output signal undergoes a state change.

19. The method of claim 17 wherein utilizing the execution path to determine if the input signal of the connected component is an active input signal of the connected component comprises:
utilizing the execution path to obtain an equation that generates the value of the start-point active output signal according to signals within the execution path, wherein if the input signal of the connected component is not within the equation, then the input signal of the connected component is not an active input signal of the connected component; and
parsing the equation to determine if the input signal of the connected component within the equation is a required signal for the value of the start-point active output signal; wherein if the input signal of the connected component is a required signal, then the input signal of the connected component is an active input signal of the connected component.

20. The method of claim 19 wherein utilizing the HDL code and the simulation results to obtain the execution path of the connected component at the execution time comprises:
parsing the HDL code corresponding to the connected component to obtain at least an instruction node, each instruction node corresponding to a logical instruction step of the HDL code; and
utilizing the simulation results corresponding to a time on or before the execution time and the at least an instruction node to back-trace the at least an instruction node to determine which instruction nodes of the connected component are executed on or before the execution time to obtain the value of the start-point active output signal, wherein the execution path consists of all instruction nodes executed to generate the value of the start-point active output signal at the execution time; and
utilizing the execution path to obtain the equation that generates the value of the start-point active output signal comprises:
linking logical statements derived from each instruction node in the execution path together by a logical AND operator to obtain a Boolean equation that generates the value of the start-point active output signal according to signals in the logical statements.

21. The method of claim 17 wherein the start-point active output signal has an associated local output time, and the active input signal of the connected component has an associated local input time that is the latest simulation time on or before the local output time at which the active input signal of the connected component undergoes a state change; wherein the local input time is utilized as a local output time in a subsequent iteration of the backward search method.

22. The method of claim 21 wherein the execution time is a simulation time on or before the local output time.

23. The method of claim 21 wherein a differentiated active component is provided to the user in a differentiated manner according to the local input time or the local output time of the differentiated active component.

24. The method of claim 23 wherein required signals of the active output signal of the differentiated active component are further provided.

25. The method of claim 24 wherein values of the required signals at the local output time or the local input time are further provided.

26. The method of claim 23 further comprising utilizing the user input equipment to obtain a break point time from the user, and selecting the differentiated active component according to the break point time.

27. The method of claim 21 further comprising an animated display of the active components or active signals according to the local input times or the local output times.

28. The method of claim 17 further comprising adding the connected component to an active component list, and adding the input signal of the connected component to an active signal list if the input signal of the connected component is an active input signal of the connected component.

29. The method of claim 1 wherein the active components are found by:
iterating a forward search method to obtain a first set of active components, the first iteration of the forward search method utilizing the at least a start signal as an input active signal;
iterating a backward search method to obtain a second set of active components, the first iteration of the backward search method utilizing the at least a stop signal as an output active signal; and
intersecting the first set of active components with the second set of active components to obtain the active components.

30. An active forward search method for hardware description language (HDL) code in a computer system, the computer system comprising user input equipment for accepting input from a user, and user output equipment for providing output to the user, the HDL code being used to represent an electronic circuit having a plurality of components, each component having at least an input signal and an output signal, the method comprising:
utilizing the user input equipment to obtain at least a start signal from the user, the at least a start signal being an input signal;
utilizing the user input equipment to obtain a start time;
obtaining simulation results of the electronic circuit from a simulator that utilizes the HDL code, the simulation results having state changes of the output signals and the input signals;
parsing the HDL code to obtain a circuit connection graph fanning out from the at least a start signal, the connection graph comprising components, input signals, and output signals;
iterating a forward search method comprising:
obtaining an active input signal;
utilizing the connection graph to obtain a connected component, the connected component having the active input signal as an input signal of the connected corn ponent;
utilizing the HDL code and the simulation results to obtain an execution path of the connected component at an execution time that is on or after the start time; and
utilizing the execution path to determine if an output signal of the connected component is an active output signal of the connected component, wherein the output signal of the connected component is an active output signal of the connected component only if the output signal of the connected component obtains a state in response to a state change of the active input signal;
wherein the active output signal of the connected component is utilized as an active input signal in a subsequent iteration of the forward search method, and
any component in the connection graph having an active output signal is an active component;
wherein the first iteration of the forward search method utilizes the at least a start signal as the active input signal; and
utilizing the user output equipment to provide the active components or the active output signals to the user.

31. The method of claim 30 in which the user output equipment is utilized to provide both the active components and the active output signals to the user.

32. The method of claim 30 wherein utilizing the execution path to determine if the output signal of the connected component is an active output signal of the connected component comprises:
utilizing the execution path to obtain an equation that generates a value of the output signal of the connected component according to at least an input signal of the connected component, wherein if the active input signal is not within the equation, then the output signal of the connected component is not an active output signal of the connected component; and
parsing the equation to determine if the active input signal within the equation is a required signal for the value of the output signal of the connected component; wherein if the active input signal is a required signal, then the output signal of the connected component is an active output signal of the connected component.

33. The method of claim 32 wherein utilizing the HDL code and the simulation results to obtain the execution path of the connected component at the execution time comprises:
parsing the HDL code corresponding to the connected component to obtain at least an instruction node, each instruction node corresponding to a logical instruction step of the HDL code; and
iteratively substituting simulation results corresponding to a time on or after the execution time into the at least an instruction node according to the at least an instruction node to determine which instruction nodes of the connected component are executed at or after the execution time to obtain the value of the output signal of the connected component, wherein the execution path consists of all executed instruction nodes; and
utilizing the execution path to obtain the equation that generates the value of the output signal of the connected component comprises:
linking logical statements derived from each instruction node in the execution path together by a logical AND operator to obtain a Boolean equation that generates the value of the output signal of the connected component according to at least an input signal of the connected component.

34. The method of claim 33 wherein the at least an instruction node of the connected component includes an entry-point node that must be satisfied before other instruction nodes of the connected component are subsequently executed, and the simulation results at the execution time satisfy the entry-point node.

35. The method of claim 34 wherein the execution time is a simulation time that is closest to the start time.

36. The method of claim 34 wherein the execution time is a simulation time that is closest to a state change of the at least a start signal.

37. The method of claim 30 wherein the active input signal has an associated local input time, and the active output signal of the connected component has an associated local output time that is the earliest simulation time on or after the local input time at which the output signal of the connected component obtains a state in response to a state change of the active input signal; wherein the local output time is utilized as a local input time in a subsequent iteration of the forward search method.

38. The method of claim 37 wherein the execution time is a simulation time on or after the local input time.

39. The method of claim 37 wherein a differentiated active component is provided to the user in a differentiated manner according to the local input time or the local output time of the differentiated active component.

40. The method of claim 39 wherein required signals of the active output signal of the differentiated active component are further provided.

41. The method of claim 40 wherein values of the required signals at the local output time or the local input time are further provided.

42. The method of claim 39 further comprising utilizing the user input equipment to obtain a break point time from the user, and selecting the differentiated active component according to the break point time.

43. The method of claim 37 further comprising an animated display of the active components or active signals according to the local input times or the local output times.

44. The method of claim 30 further comprising adding the connected component to an active component list if the output signal of the connected component is an active output signal, and adding the output signal of the connected component to an active signal list if the output signal of the connected component is an active output signal.

45. An active backward search method for hardware description language (HDL) code in a computer system, the computer system comprising user input equipment for accepting input from a user, and user output equipment for providing output to the user, the HDL code being used to represent an electronic circuit having a plurality of components, each component having at least an input signal and an output signal, the method comprising:
utilizing the user input equipment to obtain at least a stop signal from the user, the at least a stop signal being an output signal;
utilizing the user input equipment to obtain a stop time;
obtaining simulation results of the electronic circuit from a simulator that utilizes the HDL code, the simulation results having state changes of the output signals and the input signals;
parsing the HDL code to obtain a circuit connection graph fanning into the at least a stop signal, the connection graph comprising components, input signals, and output signals;
iterating a backward search method comprising:
obtaining a start-point active output signal;
utilizing the connection graph to obtain a connected component, the connected component having the start-point active output signal as an output signal of the connected component;
utilizing the HDL code and the simulation results to obtain an execution path of the connected component at an execution time that is on or before the stop time; and
utilizing the execution path to determine if an input signal of the connected component is an active input signal of the connected component, wherein the input signal of the connected component is an active input signal of the connected component only if the start-point active output signal obtains a state in response to a state change of the input signal of the connected component;
wherein the active input signal of the connected component is utilized as a start-point active output signal in a subsequent iteration of the backward search method;
wherein the first iteration of the backward search method utilizes the at least a stop signal as the start-point active output signal; and
utilizing the user output equipment to provide the active components, the active output signals, or the active input signals to the user.

46. The method of claim 45 in which the user output equipment is utilized to provide the active components, the active output signals, and the active input signals to the user.

47. The method of claim 45 wherein the execution time is a simulation time at which the start-point active output signal undergoes a state change.

48. The method of claim 45 wherein utilizing the execution path to determine if the input signal of the connected component is an active input signal of the connected component comprises:
utilizing the execution path to obtain an equation that generates the value of the start-point active output signal according to signals within the execution path, wherein if the input signal of the connected component is not within the equation, then the input signal of the connected component is not an active input signal of the connected component; and
parsing the equation to determine if the input signal of the connected component within the equation is a required signal for the value of the start-point active output signal; wherein if the input signal of the connected component is a required signal, then the input signal of the connected component is an active input signal of the connected component.

49. The method of claim 48 wherein utilizing the HDL code and the simulation results to obtain the execution path of the connected component at the execution time comprises:
parsing the HDL code corresponding to the connected component to obtain at least an instruction node, each instruction node corresponding to a logical instruction step of the HDL code; and
utilizing the simulation results corresponding to a time on or before the execution time and the at least an instruction node to back-trace the at least an instruction node to determine which instruction nodes of the connected component are executed on or before the execution time to obtain the value of the start-point active output signal, wherein the execution path consists of all instruction nodes executed to generate the value of the start-point active output signal at the execution time; and
utilizing the execution path to obtain the equation that generates the value of the start-point active output signal comprises:
linking logical statements derived from each instruction node in the execution path together by a logical AND operator to obtain a Boolean equation that generates the value of the start-point active output signal according to signals in the logical statements.

50. The method of claim 45 wherein the start-point active output signal has an associated local output time, and the active input signal of the connected component has an associated local input time that is the latest simulation time on or before the local output time at which the active input signal of the connected component undergoes a state change; wherein the local input time is utilized as a local output time in a subsequent iteration of the backward search method.

51. The method of claim 50 wherein the execution time is a simulation time on or before the local output time.

52. The method of claim 50 wherein a differentiated active component is provided to the user in a differentiated manner according to the local input time or the local output time of the differentiated active component.

53. The method of claim 52 wherein required signals of the active output signal of the differentiated active component are further provided.

54. The method of claim 53 wherein values of the required signals at the local output time or the local input time are further provided.

55. The method of claim 52 further comprising utilizing the user input equipment to obtain a break point time from the user, and selecting the differentiated active component according to the break point time.

56. The method of claim 50 further comprising an animated display of the active components or active signals according to the local input times or the local output times.

57. The method of claim 45 further comprising adding the connected component to an active component list, and adding the input signal of the connected component to an active signal list if the input signal of the connected component is an active input signal of the connected component.

58. A computer system comprising:
input equipment for obtaining data from a user;
output equipment for providing data to the user;
a central processing unit (CPU) for controlling functionality of the computer system; and
a memory comprising program code that is executable by the CPU to direct operations of the CPU, the program code containing instructions for:
obtaining hardware description language (HDL) code, the HDL code being used to represent an electronic circuit having a plurality of components, each component having at least an input signal and an output signal;
utilizing the user input equipment to obtain at least a start signal from the user, the at least a start signal being an output signal or an input signal;
utilizing the user input equipment to obtain at least a stop signal from the user, the at least a stop signal being an output signal or an input signal;
utilizing the user input equipment to obtain a start time and a stop time;
obtaining simulation results generated by a simulator according to the HDL code, the simulation results having state changes of the output signals and the input signals;
parsing the HDL code to obtain a circuit connection graph between the at least a start signal and the at least a stop signal, the connection graph comprising components, input signals, and output signals that electrically connect the at least a start signal to the at least a stop signal;
utilizing the simulation results and the HDL code to determine which of the components in the circuit connection graph are active components, an active component being any component in the circuit connection graph having an active output signal, an active output signal being any output signal of any component in the circuit connection graph that obtains a state between the start time and the stop time in response to a state change of the at least a start signal according to an execution path of the HDL code; and
utilizing the user output equipment to provide the active components or the active output signals to the user.

59. The computer system of claim 58 in which the program code utilizes the user output equipment to provide both the active components and the active output signals to the user.

60. The computer system of claim 58 wherein the active components are found by iterating a forward search algorithm in the program code, the forward search algorithm containing instructions for:
obtaining an active input signal;
utilizing the connection graph to obtain a connected component, the connected component having the active input signal as an input signal of the connected component;
utilizing the HDL code and the simulation results to obtain the execution path of the connected component at an execution time that is between the start time and the stop time; and
utilizing the execution path to determine if an output signal of the connected component is an active output signal of the connected component, wherein the output signal of the connected component is an active output signal of the connected component only if the output signal of the connected component obtains a state in response to a state change of the active input signal;
wherein the active output signal of the connected component is utilized as an active input signal in a subsequent iteration of the forward search algorithm;
wherein the first iteration of the forward search algorithm utilizes the at least a start signal as the active input signal.

61. The computer system of claim 60 wherein utilizing the execution path to determine if the output signal of the connected component is an active output signal of the connected component contains instructions for:
utilizing the execution path to obtain an equation that generates a value of the output signal of the connected component according to at least an input signal of the connected component, wherein if the active input signal is not within the equation, then the output signal of the connected component is not an active output signal of the connected component; and
parsing the equation to determine if the active input signal within the equation is a required signal for the value of the output signal of the connected component; wherein if the active input signal is a required signal, then the output signal of the connected component is an active output signal of the connected component.

62. The computer system of claim 61 wherein utilizing the HDL code and the simulation results to obtain the execution path of the connected component at the execution time contains instructions for:
parsing the HDL code corresponding to the connected component to obtain at least an instruction node, each instruction node corresponding to a logical instruction step of the HDL code; and
iteratively substituting simulation results corresponding to a time on or after the execution time into the at least an instruction node according to the at least an instruction node to determine which instruction nodes of the connected component are executed at or after the execution time to obtain the value of the output signal of the connected component, wherein the execution path consists of executed instruction nodes; and
utilizing the execution path to obtain the equation that generates the value of the output signal of the connected component contains instructions for:
linking logical statements derived from each instruction node in the execution path together by a logical AND operator to obtain a Boolean equation that generates the output value of the output signal of the connected component according to at least an input signal of the connected component.

63. The computer system of claim 62 wherein the at least an instruction node of the connected component includes an entry-point node that must be satisfied before other instruction nodes of the connected component are subsequently executed, and the program code contains instructions for parsing the simulation results to find a value of the execution time at which the entry-point node is satisfied.

64. The computer system of claim 62 wherein the execution time is a simulation time that is closest to the start time.

65. The computer system of claim 62 wherein the execution time is a simulation time that is closest to a state change of the at least a start signal.

66. The computer system of claim 60 wherein the program code further contains instructions for providing the active input signal an associated local input time, and for providing the active output signal of the connected component an associated local output time that is the earliest simulation time on or after the local input time at which the output signal of the connected component obtains a state in response to a state change of the active input signal; wherein the local output time is utilized as a local input time in a subsequent iteration of the forward search algorithm.

67. The computer system of claim 66 wherein the program code contains instructions to ensure that the execution time is a simulation time on or after the local input time.

68. The computer system of claim 66 wherein the program code contains instructions to provide a differentiated active component to the user in a differentiated manner according to the local input time or the local output time of the differentiated active component.

69. The computer system of claim 68 wherein the program code contains instructions to provide required signals of the active output signal of the differentiated active component to the user.

70. The computer system of claim 69 wherein the program code contains instructions to provide values of the required signals at the local output time or the local input time to the user.

71. The computer system of claim 68 further comprising program code to utilize the user input equipment to obtain a break point time from the user, and program code that selects the differentiated active component according to the break point time.

72. The computer system of claim 66 further comprising program code for providing an animated display of the active components or active signals according to the local input times or the local output times.

73. The computer system of claim 60 wherein the program code comprises instructions for adding the connected component to an active component list if the output signal of the connected component is an active output signal, and instructions for adding the output signal of the connected component to an active signal list if the output signal of the connected component is an active output signal.

74. The computer system of claim 58 wherein the active components are found by iterating a backward search algorithm in the program code, the backward search algorithm containing instructions for:
obtaining a start-point active output signal;
utilizing the connection graph to obtain a connected component, the connected component having the start-point active output signal as an output signal of the connected component;
utilizing the HDL code and the simulation results to obtain the execution path of the connected component at an execution time that is between the start time and the stop time; and
utilizing the execution path to determine if an input signal of the connected component is an active input signal of the connected component, wherein the input signal of the connected component is an active input signal of the connected component only if the start-point active output signal obtains a state in response to a state change of the input signal of the connected component;
wherein the active input signal of the connected component is utilized as a start-point active output signal in a subsequent iteration of the backward search algorithm;
wherein the first iteration of the backward search algorithm utilizes the at least a stop signal as the start-point active output signal.

75. The computer system of claim 74 wherein the program code contains instructions to ensure that the execution time is a simulation time at which the start-point active output signal undergoes a state change.

76. The computer system of claim 74 wherein utilizing the execution path to determine if the input signal of the connected component is an active input signal of the connected component contains instructions for:
utilizing the execution path to obtain an equation that generates the value of the start-point active output signal according to signals within the execution path, wherein if the input signal of the connected component is not within the equation, then the input signal of the connected component is not an active input signal of the connected component; and
parsing the equation to determine if the input signal of the connected component within the equation is a required signal for the value of the start-point active output signal; wherein if the input signal of the connected component is a required signal, then the input signal of the connected component is an active input signal of the connected component.

77. The computer system of claim 76 wherein utilizing the HDL code and the simulation results to obtain the execution path of the connected component at the execution time contains instructions for:
parsing the HDL code corresponding to the connected component to obtain at least an instruction node, each instruction node corresponding to a logical instruction step of the HDL code; and
utilizing the simulation results corresponding to a time on or before the execution time and the at least an instruction node to back-trace the at least an instruction node to determine which instruction nodes of the connected component are executed on or before the execution time to obtain the value of the start-point active output signal, wherein the execution path consists of all instruction nodes executed to generate the value of the start-point active output signal at the execution time; and
utilizing the execution path to obtain the equation that generates the value of the start-point active output signal contains instructions for:
linking logical statements derived from each instruction node in the execution path together by a logical AND operator to obtain a Boolean equation that generates the value of the start-point active output signal according to signals in the logical statements.

78. The computer system of claim 74 wherein the program code further contains instructions for providing the start-point active output signal an associated local output time, and for providing the active input signal of the connected component an associated local input time that is the latest simulation time on or before the local output time at which the active input signal of the connected component undergoes a state change; wherein the local input time is utilized as a local output time in a subsequent iteration of the backward search algorithm.

79. The computer system of claim 78 wherein the program code contains instructions to ensure that the execution time is a simulation time on or before the local output time.

80. The computer system of claim 78 wherein the program code contains instructions to provide a differentiated active component to the user in a differentiated manner according to the local input time or the local output time of the differentiated active component.

81. The computer system of claim 80 wherein the program code contains instructions for providing required signals of the active output signal of the differentiated active component to the user.

82. The computer system of claim 81 wherein the program code contains instructions for providing the values of the required signals at the local output time or the local input time to the user.

83. The computer system of claim 80 wherein the program code contains instructions for utilizing the user input equipment to obtain a break point time from the user, and instructions for selecting the differentiated active component according to the break point time.

84. The computer system of claim 78 further comprising program code for providing an animated display of the active components or active signals according to the local input times or the local output times.

85. The computer system of claim 74 wherein the program code contains instructions for adding the connected component to an active component list, and adding the input signal of the connected component to an active signal list if the input signal of the connected component is an active input signal of the connected component.

86. The computer system of claim 58 wherein the program code contains instructions for:
iterating a forward search algorithm in the program code to obtain a first set of active components, the first iteration of the forward search algorithm utilizing the at least a start signal as an input active signal;
iterating a backward search algorithm in the program code to obtain a second set of active components, the first iteration of the backward search algorithm utilizing the at least a stop signal as an output active signal; and
intersecting the first set of active components with the second set of active components to obtain the active components.

87. A computer system comprising:
input equipment for obtaining data from a user;
output equipment for providing data to the user;
a central processing unit (CPU) for controlling functionality of the computer system; and
a memory comprising program code that is executable by the CPU to direct operations of the CPU, the program code containing instructions for:
obtaining hardware description language (HDL) code, the HDL code being used to represent an electronic circuit having a plurality of components, each component having at least an input signal and an output signal;
utilizing the user input equipment to obtain at least a start signal from the user, the at least a start signal being an input signal;
utilizing the user input equipment to obtain a start time;
obtaining simulation results generated from a simulator according to the HDL code, the simulation results having state changes of the output signals and the input signals;
parsing the HDL code to obtain a circuit connection graph fanning out from the at least a start signal, the connection graph comprising components, input signals, and output signals;
iterating a forward search algorithm contained in the program code having instructions for:
obtaining an active input signal;
utilizing the connection graph to obtain a connected component, the connected component having the active input signal as an input signal of the connected corn ponent;
utilizing the HDL code and the simulation results to obtain an execution path of the connected component at an execution time that is on or after the start time; and
utilizing the execution path to determine if an output signal of the connected component is an active output signal of the connected component, wherein the output signal of the connected component is an active output signal of the connected component only if the output signal of the connected component obtains a state in response to a state change of the active input signal;
wherein the active output signal of the connected component is utilized as an active input signal in a subsequent iteration of the forward search method, and any component in the connection graph having an active output signal is an active component;
wherein the first iteration of the forward search algorithm utilizes the at least a start signal as the active input signal; and
utilizing the user output equipment to provide the active components or the active output signals to the user.

88. The computer system of claim 87 in which the program code contains instruction to utilize the user output equipment to provide both the active components and the active output signals to the user.

89. The computer system of claim 87 wherein utilizing the execution path to determine if the output signal of the connected component is an active output signal of the connected component contains instructions for:
utilizing the execution path to obtain an equation that generates a value of the output signal of the connected component according to at least an input signal of the connected component, wherein if the active input signal is not within the equation, then the output signal of the connected component is not an active output signal of the connected component; and
parsing the equation to determine if the active input signal within the equation is a required signal for the value of the output signal of the connected component; wherein if the active input signal is a required signal, then the output signal of the connected component is an active output signal of the connected component.

90. The computer system of claim 89 wherein utilizing the HDL code and the simulation results to obtain the execution path of the connected component at the execution time contains instructions for:
parsing the HDL code corresponding to the connected component to obtain at least an instruction node, each instruction node corresponding to a logical instruction step of the HDL code; and
iteratively substituting simulation results corresponding to a time on or after the execution time into the at least an instruction node according to the at least an instruction node to determine which instruction nodes of the connected component are executed at or after the execution time to obtain the value of the output signal of the connected component, wherein the execution path consists of all executed instruction nodes; and
utilizing the execution path to obtain the equation that generates the value of the output signal of the connected component contains instructions for:
linking logical statements derived from each instruction node in the execution path together by a logical AND operator to obtain a Boolean equation that generates the value of the output signal of the connected component according to at least an input signal of the connected component.

91. The computer system of claim 90 wherein the at least an instruction node of the connected component includes an entry-point node that must be satisfied before other instruction nodes of the connected component are subsequently executed, and the program code contains instructions for parsing the simulation results to find a value of the execution time at which the entry-point node is satisfied.

92. The computer system of claim 91 wherein the program code contains instruction to ensure that the execution time is a simulation time that is closest to the start time.

93. The computer system of claim 91 wherein the program code contains instruction to ensure that the execution time is a simulation time that is closest to a state change of the at least a start signal.

94. The computer system of claim 87 wherein the program code contains instruction to provide the active input signal an associated local input time, and to provide the active output signal of the connected component an associated local output time that is the earliest simulation time on or after the local input time at which the output signal of the connected component obtains a state in response to a state change of the active input signal; wherein the local output time is utilized as a local input time in a subsequent iteration of the forward search algorithm.

95. The computer system of claim 94 wherein the program code contains instructions to ensure that the execution time is a simulation time on or after the local input time.

96. The computer system of claim 94 wherein the program code contains instructions to provide a differentiated active component to the user in a differentiated manner according to the local input time or the local output time of the differentiated active component.

97. The computer system of claim 96 wherein the program code contains instructions to provide required signals of the active output signal of the differentiated active component to the user.

98. The computer system of claim 97 wherein the program code contains instructions to provide values of the required signals at the local output time or the local input time to the user.

99. The method of claim 96 wherein the program code contains instructions for utilizing the user input equipment to obtain a break point time from the user, and for selecting the differentiated active component according to the break point time.

100. The computer system of claim 94 further comprising program code for providing an animated display of the active components or active signals according to the local input times or the local output times.

101. The computer system of claim 87 wherein the program code contains instructions for adding the connected component to an active component list if the output signal of the connected component is an active output signal, and for adding the output signal of the connected component to an active signal list if the output signal of the connected component is an active output signal.

102. A computer system comprising:
input equipment for obtaining data from a user;
output equipment for providing data to the user;
a central processing unit (CPU) for controlling functionality of the computer system; and
a memory comprising program code that is executable by the CPU to direct operations of the CPU, the program code containing instructions for:
obtaining hardware description language (HDL) code, the HDL code being used to represent an electronic circuit having a plurality of components, each component having at least an input signal and an output signal;
utilizing the user input equipment to obtain at least a stop signal from the user, the at least a stop signal being an output signal;
utilizing the user input equipment to obtain a stop time;
obtaining simulation results of the electronic circuit from a simulator that utilizes the HDL code, the simulation results having state changes of the output signals and the input signals;
parsing the HDL code to obtain a circuit connection graph fanning into the at least a stop signal, the connection graph comprising components, input signals, and output signals;
iterating a backward search algorithm comprising:
obtaining a start-point active output signal;
utilizing the connection graph to obtain a connected component, the connected component having the start-point active output signal as an output signal of the connected component;
utilizing the HDL code and the simulation results to obtain an execution path of the connected component at an execution time that is on or before the stop time; and
utilizing the execution path to determine if an input signal of the connected component is an active input signal of the connected component, wherein the input signal of the connected component is an active input signal of the connected component only if the tart-point active output signal obtains a state in response to a state change of the input signal of the connected component;
wherein the active input signal of the connected component is utilized as a start-point active output signal in a subsequent iteration of the backward search algorithm;
wherein the first iteration of the backward search algorithm utilizes the at least a stop signal as the start-point active output signal; and
utilizing the user output equipment to provide the active components, the active output signals, or the active input signals to the user.

103. The computer system of claim 102 in which the program code contains instructions to utilize the user output equipment to provide the active components, the active output signals, and the active input signals to the user.

104. The computer system of claim 102 wherein the program code contains instructions to insure that the execution time is a simulation time at which the start-point active output signal undergoes a state change.

105. The computer system of claim 102 wherein utilizing the execution path to determine if the input signal of the connected component is an active input signal of the connected component contains instructions for:
utilizing the execution path to obtain an equation that generates the value of the start-point active output signal according to signals within the execution path, wherein if the input signal of the connected component is not within the equation, then the input signal of the connected component is not an active input signal of the connected component; and
parsing the equation to determine if the input signal of the connected component within the equation is a required signal for the value of the start-point active output signal; wherein if the input signal of the connected component is a required signal, then the input signal of the connected component is an active input signal of the connected component.

106. The computer system of claim 105 wherein utilizing the HDL code and the simulation results to obtain the execution path of the connected component at the execution time contains instructions for:
parsing the HDL code corresponding to the connected component to obtain at least an instruction node, each instruction node corresponding to a logical instruction step of the HDL code; and
utilizing the simulation results corresponding to a time on or before the execution time and the at least an instruction node to back-trace the at least an instruction node to determine which instruction nodes of the connected component are executed on or before the execution time to obtain the value of the start-point active output signal, wherein the execution path consists of all instruction nodes executed to generate the value of the start-point active output signal at the execution time; and
utilizing the execution path to obtain the equation that generates the value of the start-point active output signal contains instructions for:
linking logical statements derived from each instruction node in the execution path together by a logical AND operator to obtain a Boolean equation that generates the value of the start-point active output signal according to signals in the logical statements.

107. The computer system of claim 102 wherein the program code contains instructions for providing the start-point active output signal an associated local output time, and for providing the active input signal of the connected component an associated local input time that is the latest simulation time on or before the local output time at which the active input signal of the connected component undergoes a state change; wherein the local input time is utilized as a local output time in a subsequent iteration of the backward search method.

108. The computer system of claim 107 wherein the program code contains instructions to ensure that the execution time is a simulation time on or before the local output time.

109. The computer system of claim 107 wherein the program code contains instructions for providing a differentiated active component to the user in a differentiated manner according to the local input time or the local output time of the differentiated active component.

110. The computer system of claim 109 wherein the program code contains instructions for providing required signals of the active output signal of the differentiated active component to the user.

111. The computer system of claim 110 wherein the program code contains instructions for providing values of the required signals at the local output time or the local input time to the user.

112. The computer system of claim 109 wherein the program code contains instructions for utilizing the user input equipment to obtain a break point time from the user, and for selecting the differentiated active component according to the break point time.

113. The computer system of claim 107 further comprising program code for providing an animated display of the active components or active signals according to the local input times or the local output times.

114. The computer system of claim 102 wherein the program code contains instructions for adding the connected component to an active component list, and for adding the input signal of the connected component to an active signal list if the input signal of the connected component is an active input signal of the connected component.
